(19) United States
(12) Patent Application Publication
(10) Pub. No.: US 2002/0116222 A1
(43) Pub. Date: Aug. 22, 2002

(54) Method and system for administering anticoagulation therapy

(75) Inventor: Mark Wurster, Parkville, MO (US)

Correspondence Address: DARBY & DARBY P.C., POST OFFICE BOX 5257, NEW YORK, NY, 10150-5257, US

(73) Assignee: STANDING STONE, INC.

(21) Appl. No.: 10/020,864

(22) Filed: Oct. 22, 2001

Related U.S. Application Data
(60) Provisional application No. 60/242,576, filed on Oct. 22, 2000.

(51) Int. Cl. G06F 17/60

(52) U.S. Cl. 705/2

(57) ABSTRACT

A method and system for effectively administering anticoagulation therapy, including providing a warfarin dose weekly schedule and converting a total weekly requirement into daily dosages based on the number of milligrams in the pills selected for treatment. A default pill size can be selected as well as other customizable features. Medications can be recorded simultaneously and potential drug interactions are highlighted. Dates on which the patient should return to the clinic are automatically calculated for review. The patient is provided with a hardcopy of the visit as well as the recommended warfarin dose schedule. The user is provided with several customizable options for recording pertinent visit data.

### CROSS-REFERENCE TO RELATED APPLICATIONS

The present application claims the benefit of U.S. Provisional Application No. 60/242,576, filed Oct. 22, 2000, which is herein incorporated by reference in its entirety.

### FIELD OF THE INVENTION

The present invention relates to the field of health care management, and in particular to a system and method for the administration of anticoagulation therapy.

### BACKGROUND OF THE INVENTION

Anticoagulation therapy refers to the use of medications in patients at risk with the goal of preventing abnormal clotting of the blood. This type of therapy can be applied in a wide variety of medical disorders and patient populations. Such therapy may take a number of forms, which vary in terms of medication(s) utilized, duration of therapy, setting in which the treatment is administered and potential side effects. When used effectively, anticoagulation therapy can be potentially life saving and has been repeatedly shown to decrease patient suffering and the overall cost of health care.

However, the current state of anticoagulation administration needs improvement. Standard therapies often result in inadequate patient care and poor outcomes. Many patients receive treatment that is not clinically warranted. Many others fail to receive treatment for an adequate period of time or with an appropriate intensity. Still others may receive no treatment at all and thereby suffer needlessly. These problems do not arise from a single cause. Rather, a variety of factors have been identified stemming from several sources. The medications used for anticoagulation can be problematic in themselves. They can be difficult to administer, have side effects that are potentially severe and are often expensive to monitor and/or acquire. The guidelines that would ameliorate some of these factors can be quite complex and as they change over time, present health care providers with difficulties in staying current. Outdated business practices, inefficient workflow and poor understanding of requirements for record keeping and billing also have detrimental effects on implementing anticoagulation therapy.

The implementation of software applications has addressed some of the above-described problems. A number of studies have been published in which the effects of computerized software support on various aspects of such care are examined. A review of the literature has been provided by Dennis Mungall and Lynn Oertel in the publication entitled, Software Applications in Anticoagulation, Managing Oral Anticoagulation Therapy, Aspen Publishers, Inc., Gaithersburg, Md. (1997). The authors trace development and evolution of software applications from their inception in the 1960s through the mid-1990s. Such applications vary widely in structure, purpose, and applicability.

Software applications have been used to serve a variety of roles with respect to anticoagulation therapy. Ryan, P J and Rose, P E, in the article entitled “Implementation of a Comprehensive Computerized System for Decision Support”, BR Med J, vol. 299, pp. 1207-9 (1989), describes a software application for warfarin dose prediction, while Wurster, M., in a publication entitled “A Computerized Patient Management System Improves Compliance, Efficiency and Revenue in an Anticoagulation Clinic”, accepted for publication in CHEST, Vol. 118/Number 4 (SUPPL)/October 2000, describes software for research in financial impact studies. Additional software support has been developed for other areas of research such as warfarin pharmacokinetics, heparin dose prediction, demographic data storage and retrieval, medication interactions, and clinical outcome studies. However, software applications heretofore have been unable to effectively, i.e., comprehensively and efficiently, address a combination of two or more of the above mentioned areas in the same software application.

A significant limiting factor in the use of software support for anticoagulation therapy is the rapid rate of change that now occurs throughout modem medicine. New medications, and new ways of utilizing those medications are continuously being developed. An example of this is Low Molecular Weight Heparin (LMWH), which refers to a group of medications that have only recently been approved by the FDA for use in acute and chronic anticoagulation therapy. Conventional software applications have not addressed the appropriate use of this group of medications. Guidelines for appropriate clinical standards of care with respect to anticoagulation therapy change almost yearly. By way of example, the American College of Chest Physicians (ACCP) periodically releases guidelines that address such questions as (i) Which patients are candidates for anticoagulation therapy?, (ii) How long therapy should be administered? and (iii) What measures should be taken to correct or prevent complications of therapy? Currently available software applications do not adequately address these issues. Furthermore, the inherent limitations imposed upon currently available software applications by their original design do not allow for easy or rapid upgrading.

Workflow is an area in which current systems are clearly inadequate. Traditionally, patient tests related to warfarin were sent to a laboratory. Patients are typically contacted after their initial visit in order to be given laboratory test results and possibly new prescriptions. More particularly, in most instances, the usual practice is for a patient to travel to a laboratory drawing center where a venous blood sample is taken and transported to a laboratory for analysis. A laboratory prothrombin time is performed and an international normalized ratio (INR) is derived from the results. After an undetermined length of time, the laboratory result is made available to the patient's physician. In turn, the physician determines a clinical course of action based on the laboratory results. The patient is contacted by the physician's representative, usually by phone, and given the results along with the physician's recommendation.

The course of action outlined above has a number of drawbacks. The entire process is time-consuming and may span several days. It is also labor-intensive, requiring multiple chart pulls by office personnel, numerous phone calls, and excessive amounts of physician time. There are multiple opportunities for significant errors to occur during the process, which can involve both errors of commission and omission, mistaken communication and lost laboratory results requiring repeated testing. Under the present system, informed consent and patient education are haphazard at best and totally absent or inaccurate at worst. The present system is also financially inefficient for health care providers as remuneration is minimal or absent entirely and the costs associated with each patient encounter are significant.

More recently, point of service testing devices have become available but current software applications provide inadequate support for this. Point of service testing devices enable patient tests to be administered and results provided to patients at the time of their visits. As a result, the physician has greater information at the time of the patients' visit that must be comprehensively and accurately incorporated into the diagnosis and treatment plan as well as provided to the patient in a readily understood presentation.

### SUMMARY OF THE INVENTION

It is an object of the present invention to provide a method and system for effectively administering anticoagulation therapy, including providing a warfarin dose weekly schedule and converting a total weekly requirement into daily dosages based on the number of milligrams in the pills selected for treatment.

It is another object of this invention to provide a processing flow for analyzing and administering low molecular weight heparin. Further, it is an object of this invention to provide physicians with a comprehensive list of medical issues and data in order to facilitate consideration of the patients condition in a logical, organized, consistent and comprehensive manner such that diagnosis and treatment by doctors is optimized (thereby improving the quality of patient care) and establishing the necessary documentation for billing. A comprehensive list of medical issues and data also establishes an extensive database of each patient's medical records for use by other subspecialists. In addition, when further diagnosis or treatment is rendered, the database can be used to ensure consistency of treatment and notification of interactions between current and newly prescribed medications.

A further object of the invention is to provide continuous real-time feedback to the health care providers and patients for ongoing adjustment of anticoagulation treatment plans. Another object of the invention is to provide secure access to medical information by health-care providers that is convenient, widely available and customizable. Yet another object of the invention is to provide a means by which complete, legible documentation of clinical interactions can be performed to facilitate reimbursement as well as continuous quality improvement efforts. A further object is to provide specific (ACCP) guidelines in an automated manner based on data entered by a user of the software application which raises an issue addressed by the guidelines.

In one embodiment of this invention, a system and method implemented in a web site application is provided in order to address all of the above-mentioned limitations of earlier software applications. This is the first of a line of products that allow health care providers to treat patients with a level of expertise previously associated only with medical subspecialists, while at the same time significantly decreasing the time, effort, and cost associated with that care. Other health care condition administration web site applications may be provided. Each of the applications can share commonality with the others in terms of a shared database for patient and physician demographic information, past medical history, allergies and medications.

In alternative embodiments, the system and method can be implemented in software programs available on various networks or as standalone applications. This embodiment can include the following features: a subspecialty level of expertise with automatic, comprehensive clinical decision support according to accepted clinical guidelines such that a subspecialty level of medical care can be delivered in a cost effective manner in a primary care setting. Therefore, this embodiment results in cost savings to the medical system by assisting health care professionals to make more consistent and informed decisions, providing a comprehensive “checklist of checklists” in this subspecialty field and encouraging health care professionals to treat patients according to the current standard of care. In this embodiment, the system includes access to a point of service testing device and a computer terminal.

In one embodiment of this invention, the method and system enable the user to record in real time all of the pertinent data related to the patient encounter. As the user interacts with the application, interactive decision support is automatically provided. The user is guided through the encounter in a standardized, logical manner, thus minimizing errors of omission. The user is prompted if information provided to the application is inappropriate or absent. Based on the patient's current INR value and most recent warfarin dose schedule, a new prospective warfarin schedule is determined. The dose schedule is converted to a daily dose which accounts for the selected default pill size either globally for all patients within a clinical setting or individually by patient. A default pill size can be selected in a section wherein preferences for particular information can be entered. Medications can be recorded simultaneously and potential drug interactions are highlighted. Dates on which the patient should return to the clinic are automatically calculated for review. The patient is provided with a hardcopy of the visit as well as the recommended warfarin dose schedule. The user is provided with several options for recording pertinent visit data such as electronic and/or hardcopy recording.

In one embodiment of this invention, the method and system maximize the potential benefit of a face-to-face patient encounter, with significant improvements in patient education, feedback, patient medication compliance and patient satisfaction. Since the laboratory test and therapeutic intervention based on the test result takes place during a single patient visit, the workflow process is more streamlined. This, in turn, results in a significant decrease in the number of phone calls, chart pulls and wasted physician time.

In one embodiment of this invention, the method and system provide the user with access to current ACCP guidelines pertaining to appropriate indications for anticoagulation therapy as well as recommended treatment guidelines for patients on anticoagulation therapy. Significant improvement in INR compliance rates can be achieved through the use of the system.

In one embodiment of this invention, the method and system provide the user with support designed to achieve appropriate documentation levels as required by government regulations and third party payers. This in turn allows for increased reimbursement and decreases the financial risk arising from regulatory noncompliance. The financial impact for the user can be significant and positive. The system has been designed to comply with current and anticipated HCFA (CMS) and HIPAA regulations.

In one embodiment of this invention, the method and system provide for a degree of customizability that has heretofore not been realized. Substantially all of the functions within the application can be adjusted to fit the users requirements. As an example, the algorithm used for adjusting the patient's warfarin dose can be changed if needed. Customizability enhances the ability to maintain the software application in pace with changes in therapeutics. The use of the system as a research tool is clearly self-evident and its degree of customizability will greatly facilitate research efforts in anticoagulation therapy in the future.

### BRIEF DESCRIPTION OF THE DRAWINGS

The foregoing and other features of the present invention will become more apparent from the following detailed description and drawings of illustrative embodiments of the invention wherein like reference numbers refer to similar elements through the several views and in which:

FIG. 1 is a high-level diagram of an anticoagulation therapy system in accordance with the present invention;

FIG. 2 is an exemplary “Home” screen for the anticoagulation system in accordance with the present invention with an activated Patient Search window displayed;

FIG. 3 is an exemplary screen in the anticoagulation system in accordance with the present invention in which the “Patient” menu is activated to show its default dropdown list of menu options;

FIG. 4 is an exemplary screen showing a list of the history of previous visits for a particular patient in the anticoagulation system in accordance with the present invention;

FIG. 5 is an exemplary “Overdue Patients” screen in the anticoagulation system in accordance with the present invention;

FIG. 6 is an exemplary screen in the anticoagulation system in accordance with the present invention in which the “Reports” menu is activated to show its default dropdown list of menu options;

FIGS. 7a-7g show a plurality of exemplary screens for the “Ad-Hoc” search page in the anticoagulation system in accordance with the present invention;

FIG. 8 is an exemplary screen in the anticoagulation system in accordance with the present invention in which the “Tools” menu is activated to show its default dropdown list of menu options;

FIGS. 9a-9f show exemplary “New Visit” screens in the anticoagulation system in accordance with the present invention;

FIGS. 10a-10d show an exemplary decision flow chart for the administration of LMWH in the anticoagulation system in accordance with the present invention;

FIG. 11 shows an exemplary flow chart for the entry of an INR value and the resulting feedback message in the anticoagulation system in accordance with the present invention;

FIG. 12 is a prior art anticoagulation therapy workflow diagram;

FIG. 13 is an exemplary workflow diagram of the anticoagulation therapy system in accordance with the present invention;

FIG. 14 is an exemplary warfarin dose calculation flow chart for the anticoagulation therapy system in accordance with the present invention;

FIG. 15 is an exemplary “Custom Equation Definition” screen for the anticoagulation therapy system in accordance with the present invention;

FIGS. 16a and 16b are screen shots of exemplary interactive warning messages both visual (arrows) and written based on the medications in the anticoagulation therapy system in accordance with the present invention;

FIGS. 17a-71i depict exemplary “Tab View” pages for a particular patient in the anticoagulation system once a new visit has been established in accordance with the present invention; and

FIGS. 18a-18c shows exemplary “Preference” screens for the anticoagulation therapy system in accordance with the present invention.

### DETAILED DESCRIPTION OF THE INVENTION

For the purposes of the following invention, the term “user” is defined as a physician, technician, nurse, or other medical practitioner that registers with the service or is otherwise permitted to access the anticoagulation therapy web site. In addition, the page layout, menus, categories and fields may be modified, as desired and still remain within the scope of the invention.

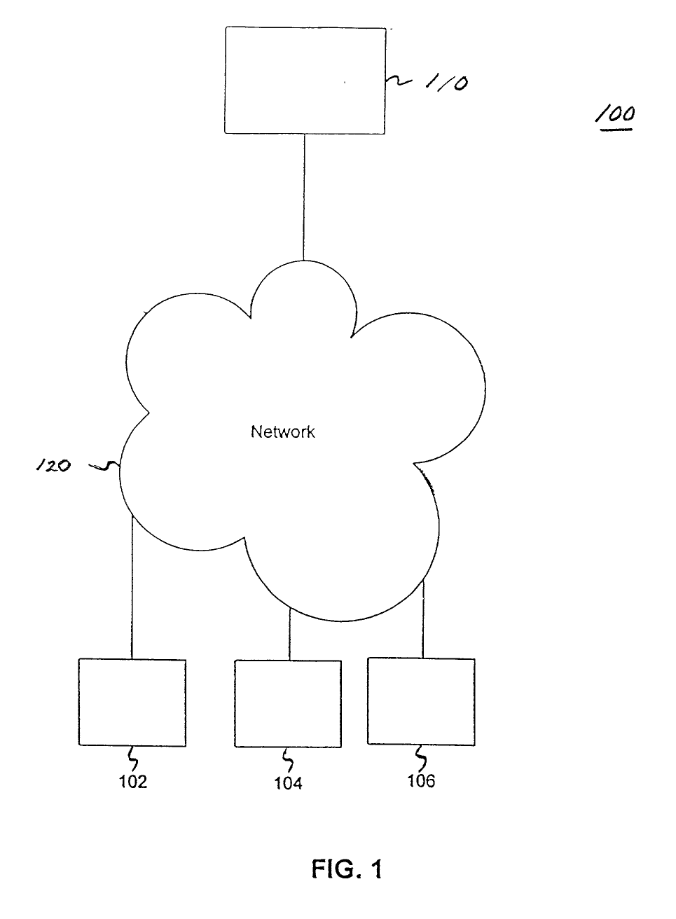

FIG. 1 is a high-level diagram of an anticoagulation therapy system 100 in accordance with the present invention. The system 100 includes a server 110 that is used to run the software applications necessary for developing the anticoagulation regimen. System 100 is accessed by multiple computer terminals 102, 104, 106 connected through a network 120, such as the Internet, World Wide Web (WWW), local area network (LAN), wide area network (WAN), various wireless technology platforms, Intranet or anywhere the system and software are accessible by users from remote locations.

Although only three computers are shown, any number of computers may be connected to the network through known communication interface means, such as an external or a built-in modem. User may subscribe to access the system from any computer terminal throughout the world having appropriate network Internet access and software, such as a web browser. Users visit a web site to access the anticoagulation system in accordance with the present invention.

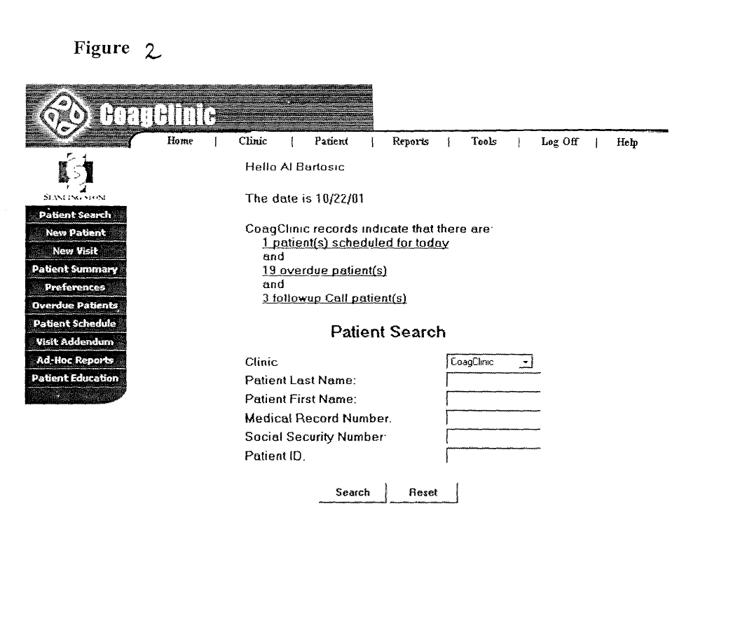

FIG. 2 is an exemplary “Home” page for the anticoagulation system in accordance with the present invention that is automatically displayed upon the user visiting the web site. This screen serves as a starting point for accessing any of the system's features and functions. The welcome message initially displayed when the screen is generated summarizes the total number of patients scheduled for the current date as determined by the Visit Due Date entered at the patient's most recent past visit, as well as a total number of patients who may be overdue for a visit (defined by the patient's Visit Due Date plus a certain number of days).

Along the top of the “Home” screen is a pull down menu bar with a plurality of functional options. A customizable supplemental tool bar of commonly used options is provided along the left hand side of the “Home” page. In the exemplary screen shown in FIG. 2 the menu bar includes the following options: “Home”, “Clinic”, “Patient”, “Reports”, “Tools”, “Log Off” and “Help”. The tool bar can be modified, as desired, to include less than or more than the options provided in FIG. 2. Each menu will now be described separately.

The “Clinic” menu identifies a list of related clinics with a hyperlink to the Home page of the web site for that clinic. Related web sites, for example may include, a cholesterol clinic, diabetes clinic or hematology clinic. System administrators can configure this feature to link to any desired web site. In a preferred embodiment, only those clinics to which the user subscribes are highlighted in the menu.

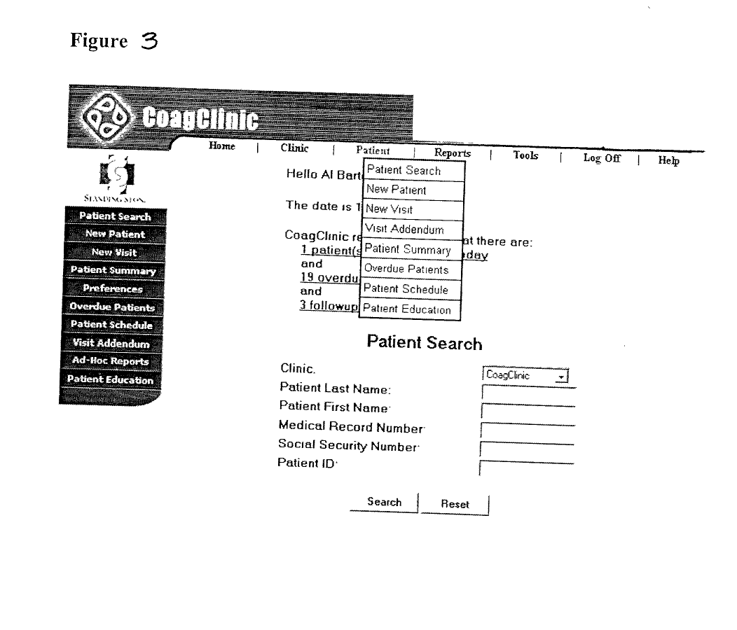

“Patient” menu provides the users with a dropdown menu list of default options. In the exemplary embodiment shown in FIG. 3, the following default options are provided in the “Patient” menu (FIG. 3): “Patient Search”, “New Patient”, “New Visit”, “Visit Addendum”, “Patient Summary”, “Overdue Patients”, “Patient Schedule” and “Patient Education”.

The user can search for a particular patient chart by selecting the “Patient Search” option. FIG. 2 shows the data entry fields to be completed to develop a search query. The search query can be created by providing at least one of the patient's last name, first name, Medical Record #, Social Security #, or Patient ID #. The searching functionality conforms with accepted operations and allows the user to enter one or more letters instead of completing the entire data entry field. For example, a search can be conducted based on a first name and the initial of the patient's last name. Alternatively a search may conducted exclusively by way of the patient's first name. Once the desired information has been entered, the user presses the “Search” button to initiate the search.

In response to the user selecting the “New Patient” option, the server generates a “New Visit” page (described in detail below) with all of the data entry fields left blank. Similarly, the “New Visit” option when activated causes the server to display a “New Visit” page with the respective data fields automatically populated with information appropriate to the active patient. If no patient has been selected then this option is identical to that of the “New Patient” option described above.

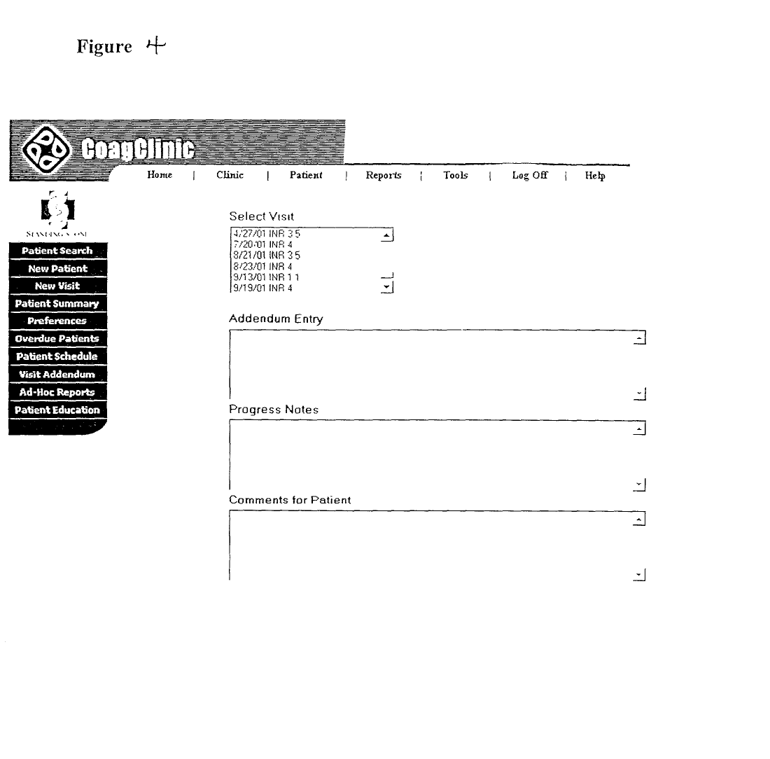

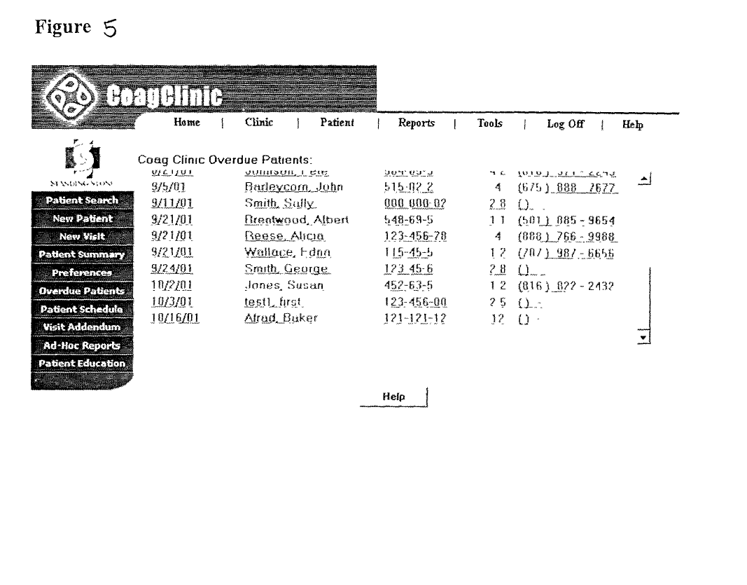

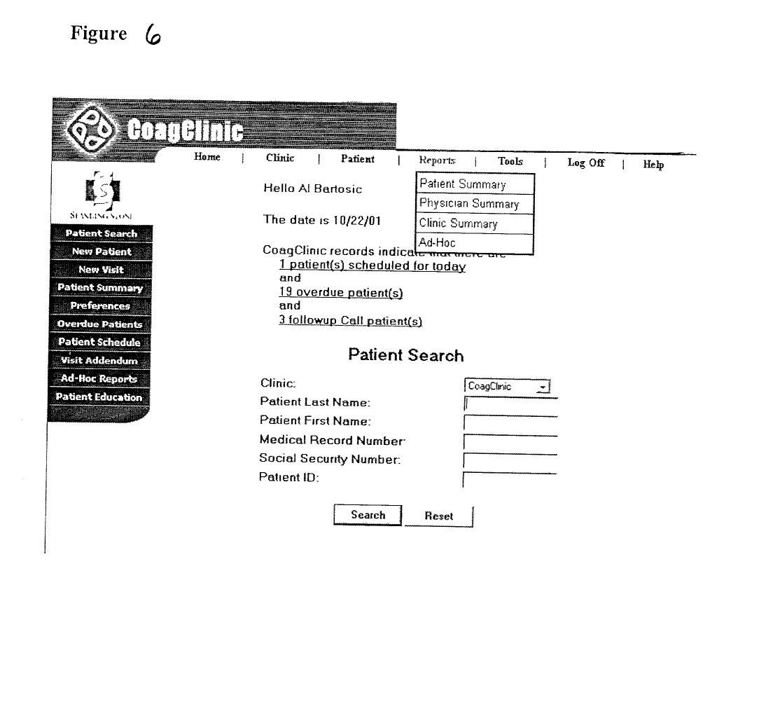

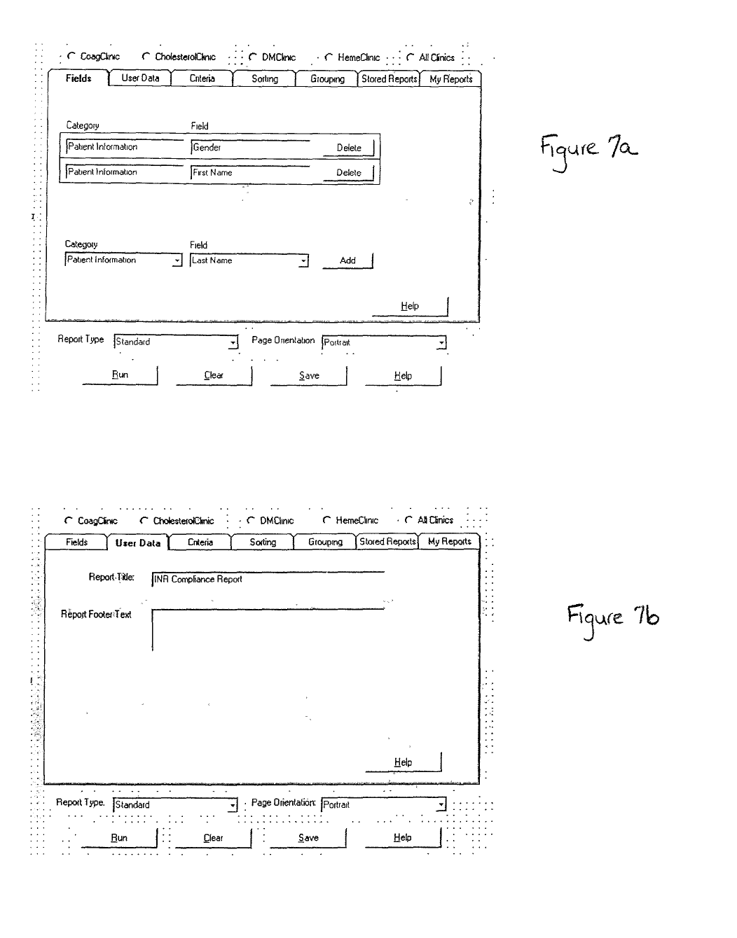

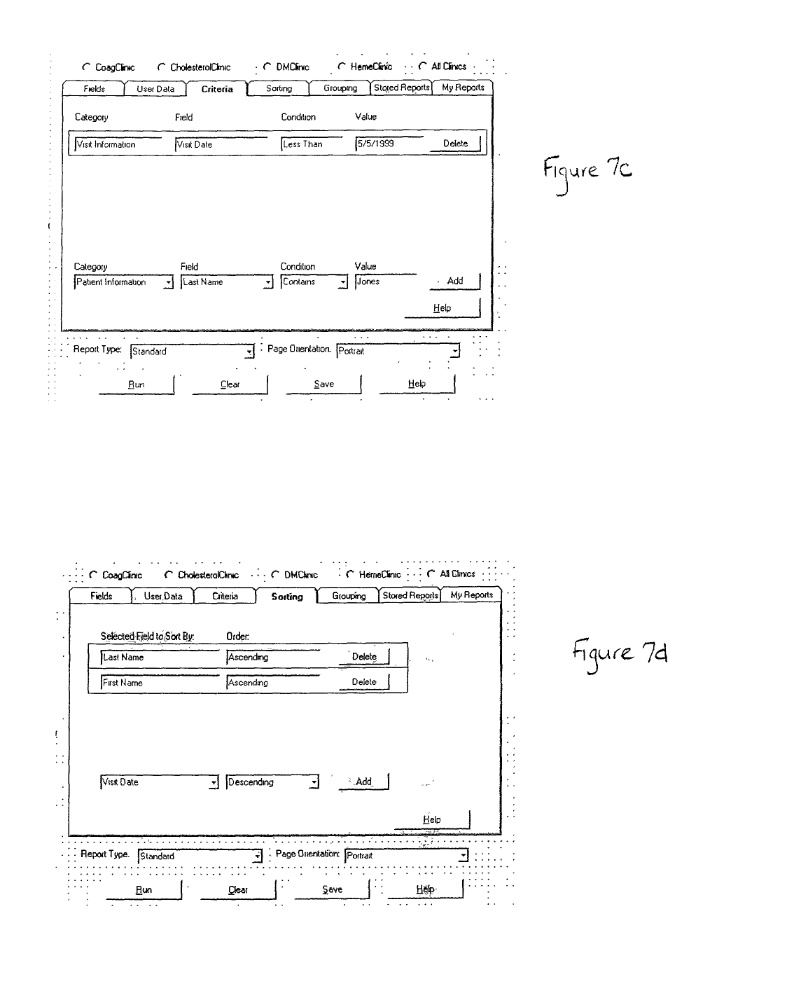

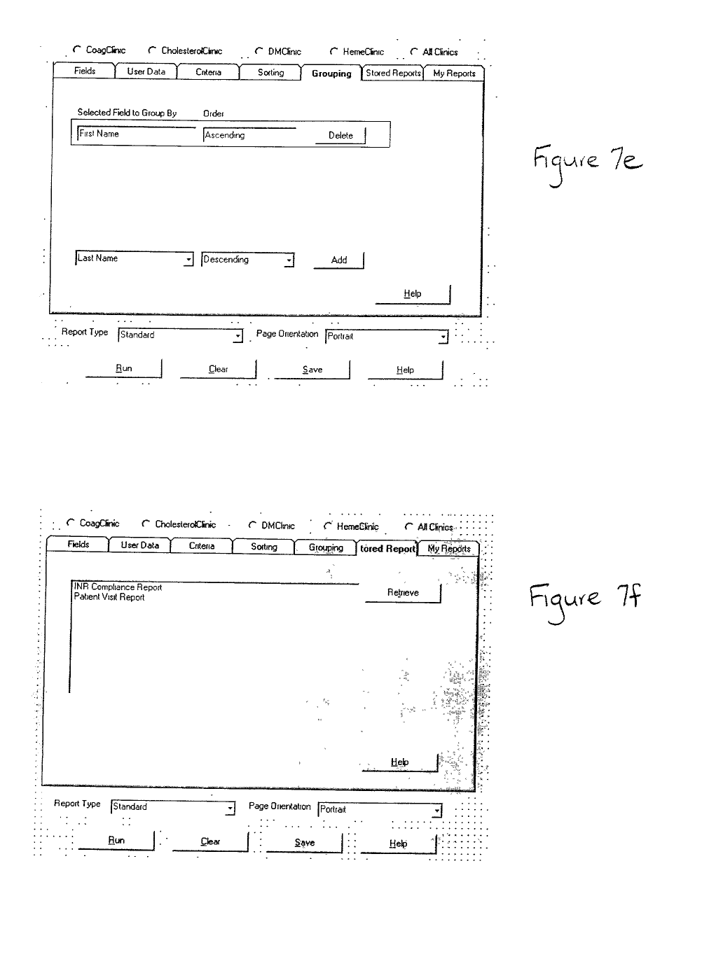

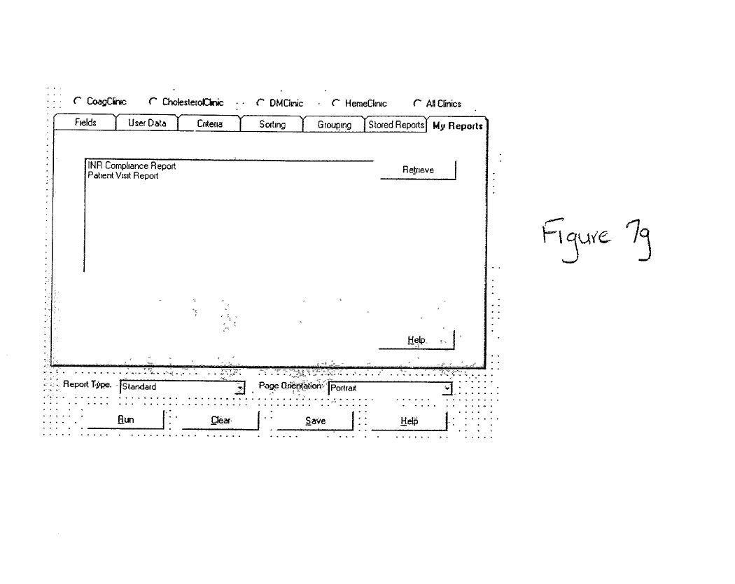

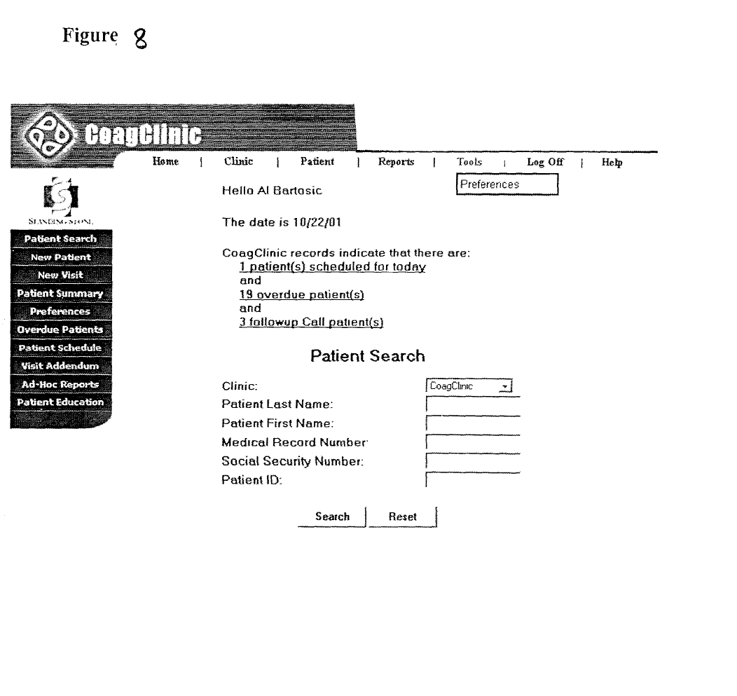

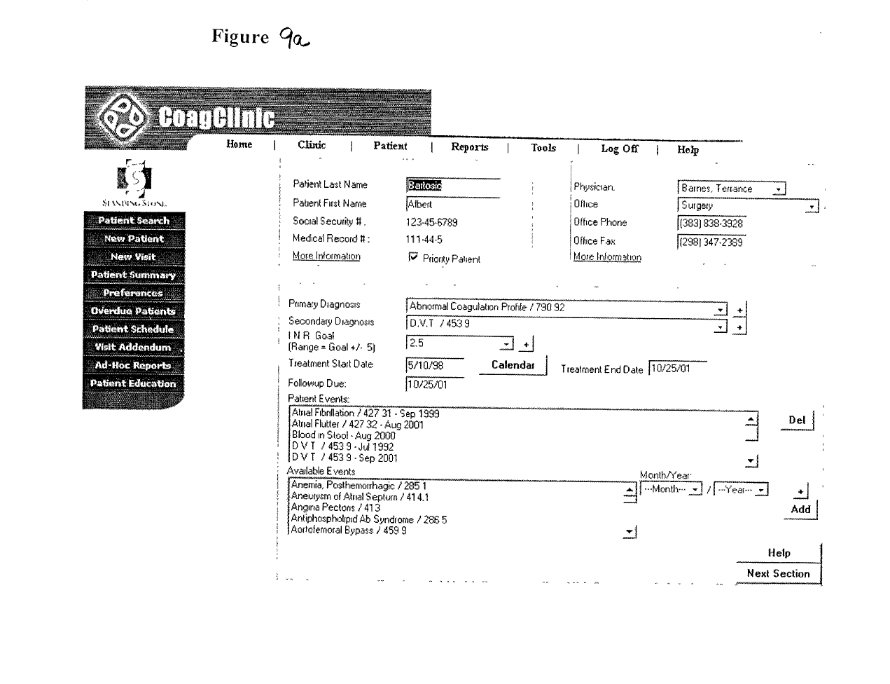

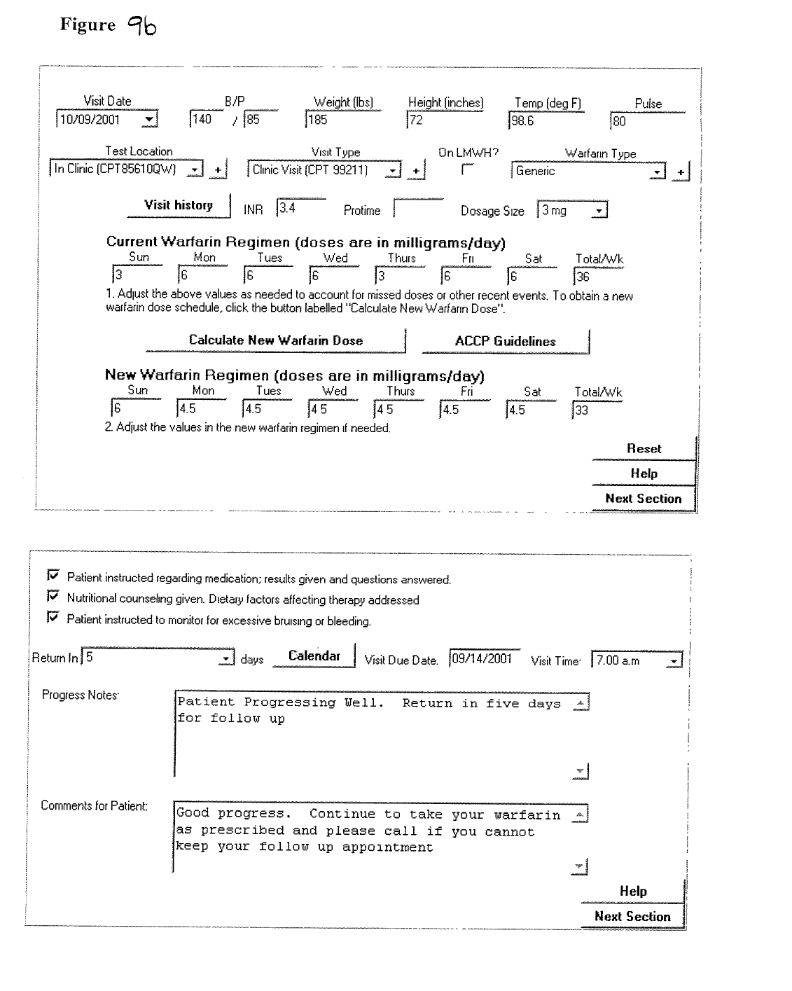

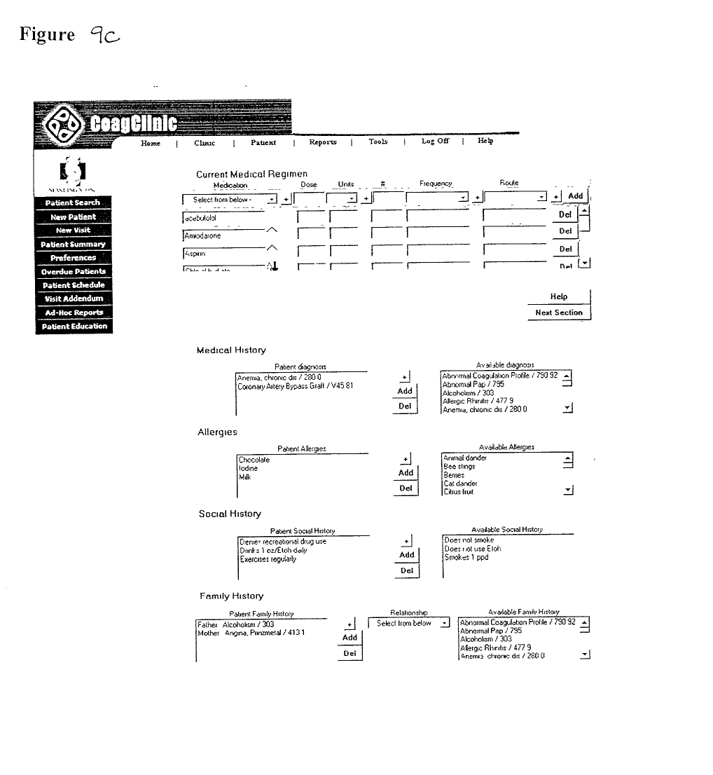

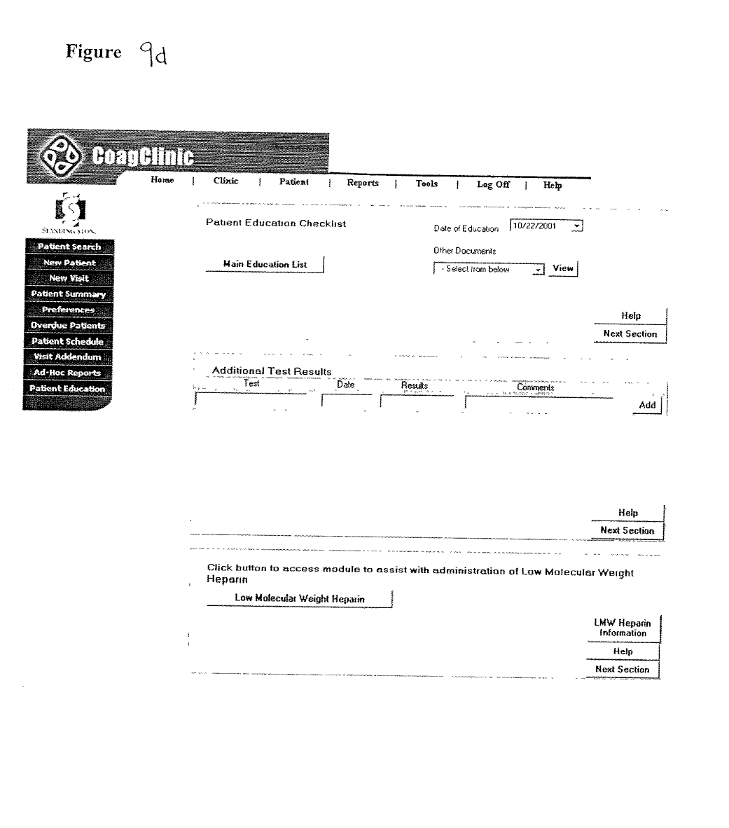

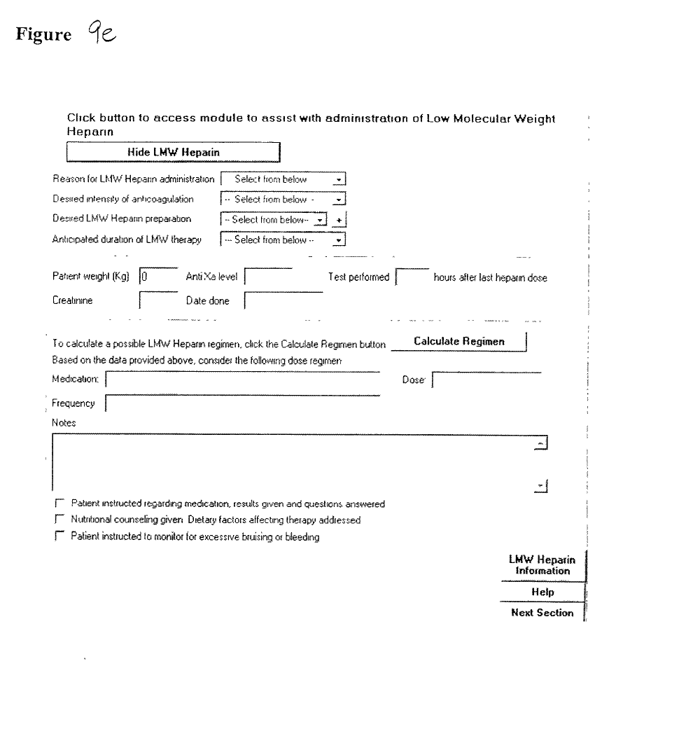

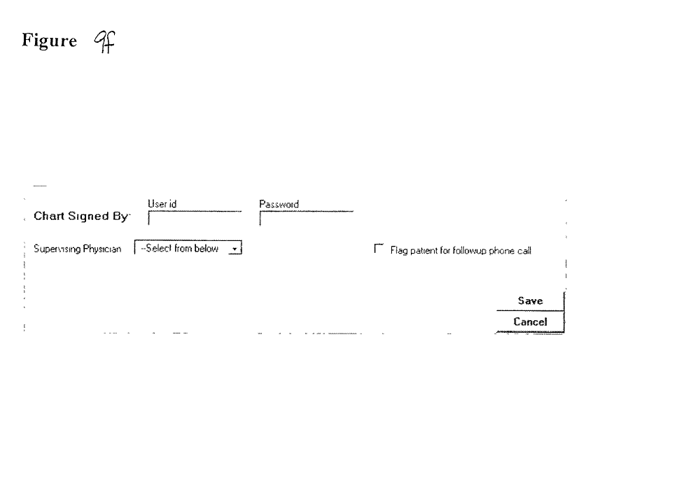

A user can edit information associated with a visit by selecting the “Visit Addendum” option. This option is only available when an established patient record is active. FIG. 4 is a screen shot showing an exemplary list of the history of previous visits for a particular patient displayed in response to the user selecting the “Visit Addendum” button. A particular visit to be edited is selected from the list of available recorded visits for the patient and then the user enters the desired information and/or comments in the “Addendum Entry” data field in FIG. 4. In addition, the user may update medical history and or additional patient medications. After being entered the information is recorded by selecting the “Save” button and the previous screen is again displayed.

The “Patient Summary” option is available only after a patient has been selected and activates the “New Visit” page, described in detail below.

By clicking the “Overdue Patients” option, the server 100 displays a screen showing a list of patient names for an active clinic who are overdue for a visit. The determination of whether a patient is “overdue” for a visit is defined by their Visit Due Date plus a specified number of days. FIG. 5 is an exemplary “Overdue Patients” screen. In a preferred embodiment, the list of overdue patients can be sorted, for example, by last name or alphabetical order. By default, the names are listed in chronological order of visit due dates. The day of the patient's most recent visit is listed to the left of the patient's name, while the patient's medical record number, INR and home phone number is left to the right of their name. Clicking on a patient entry from the list will generate a “New Visit” (FIG. 9) screen for the selected patient, described in detail below. In response to the user clicking on the “Patient Schedule” option from the “Patient” menu in FIG. 3, a similar display to that of the “Overdue Patients” option is generated by the server and provides a list of patients that are scheduled to visit the clinic on that day. Clicking on a particular patient will cause the server to display a “New Visit” page for the selected patient.

The “Patient Education” option entry under the “Patient” menu displays a list of educational related documents and/or interactive lists that the user can read to obtain related information.

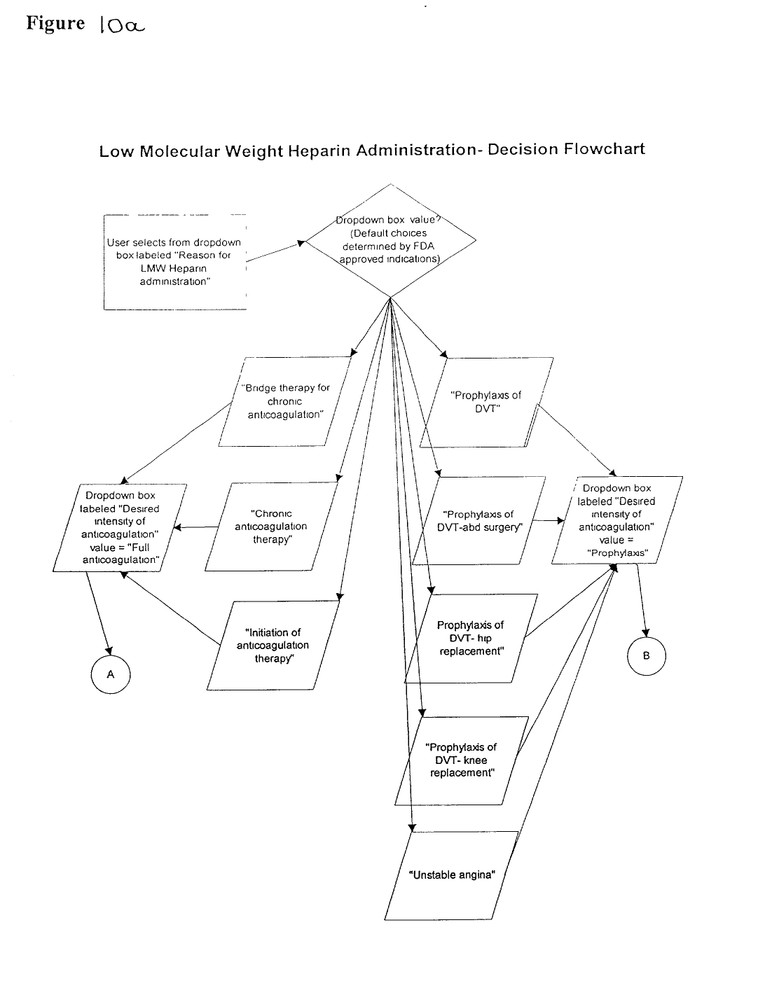

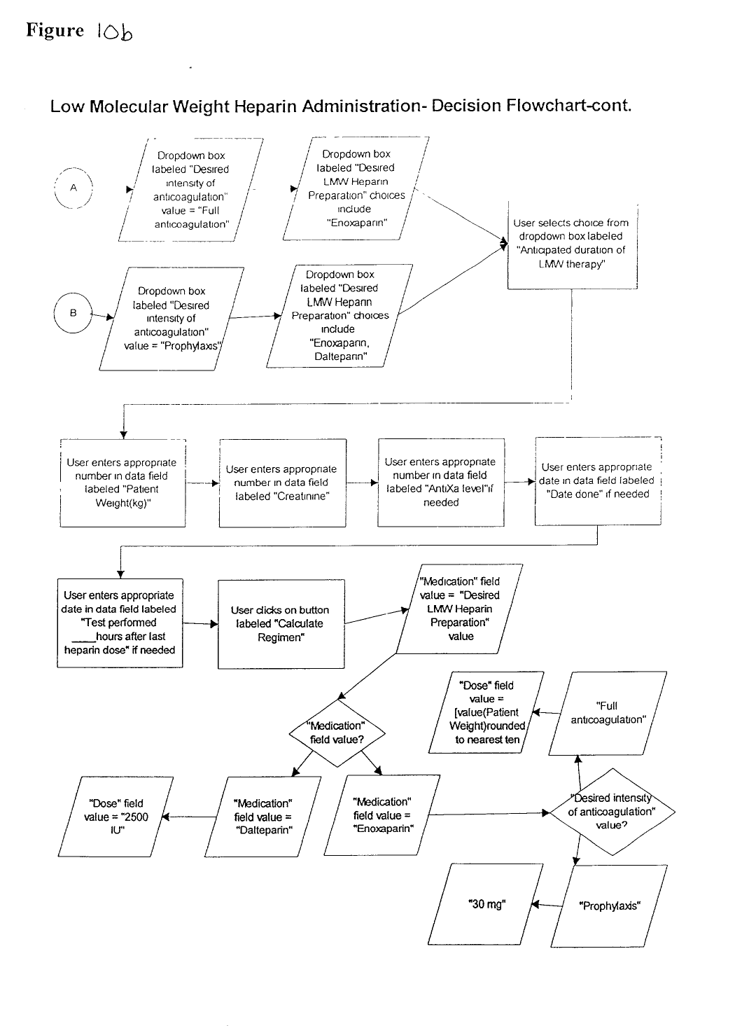

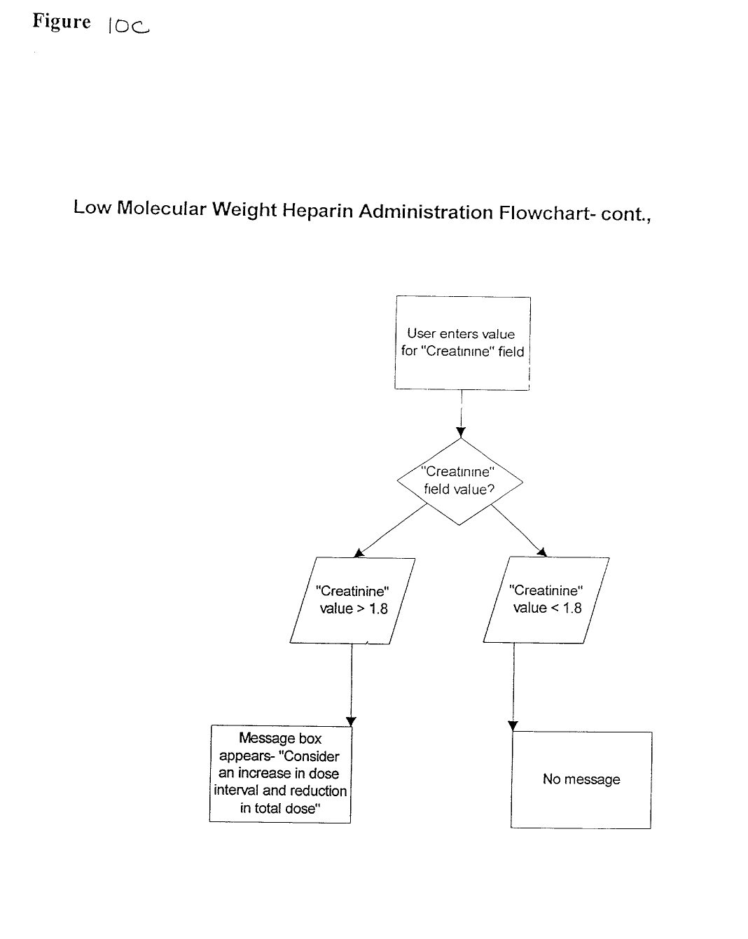

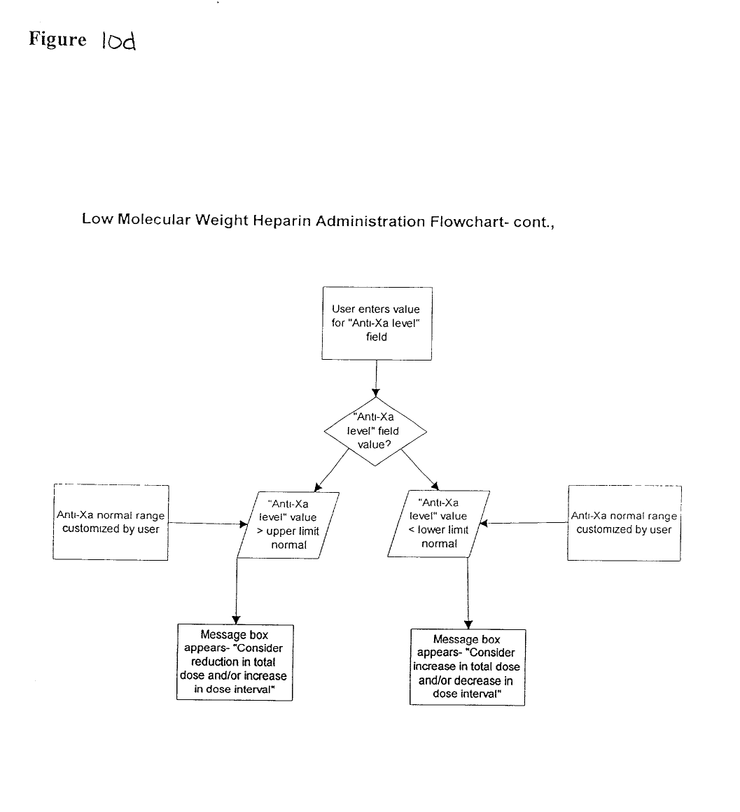

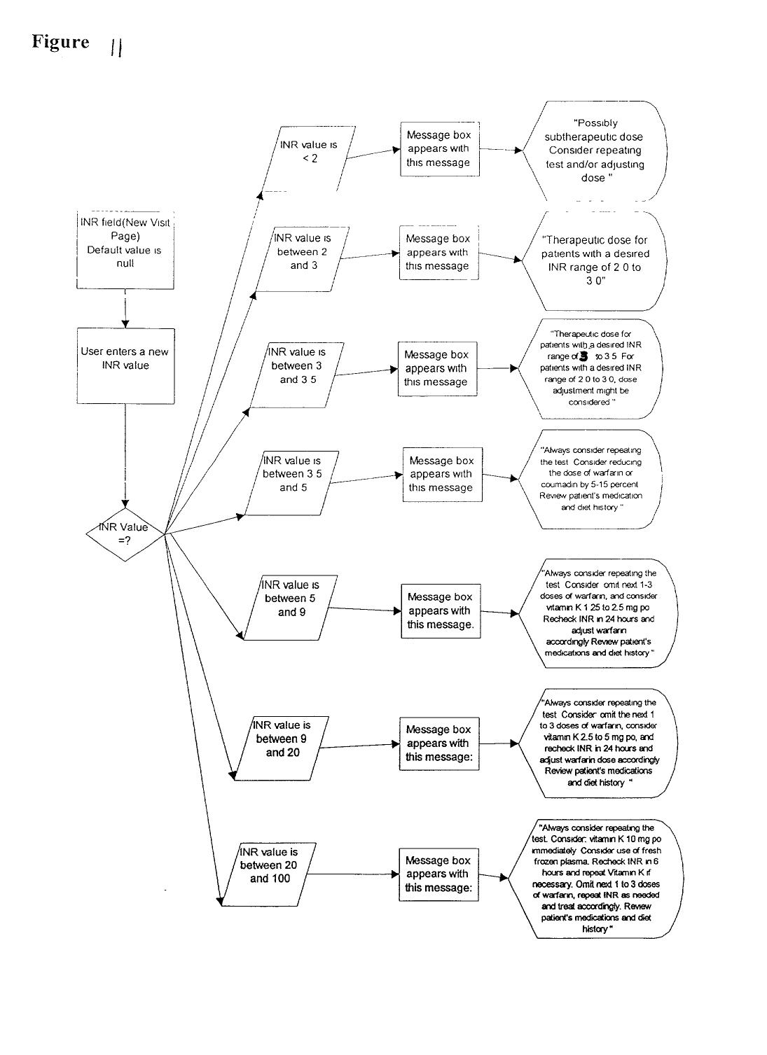

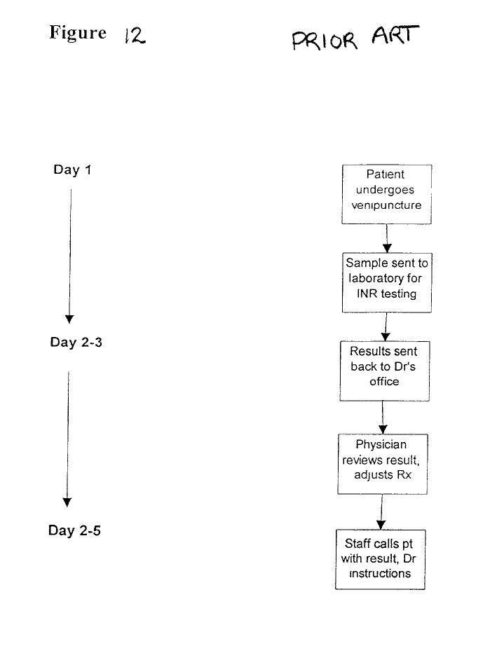

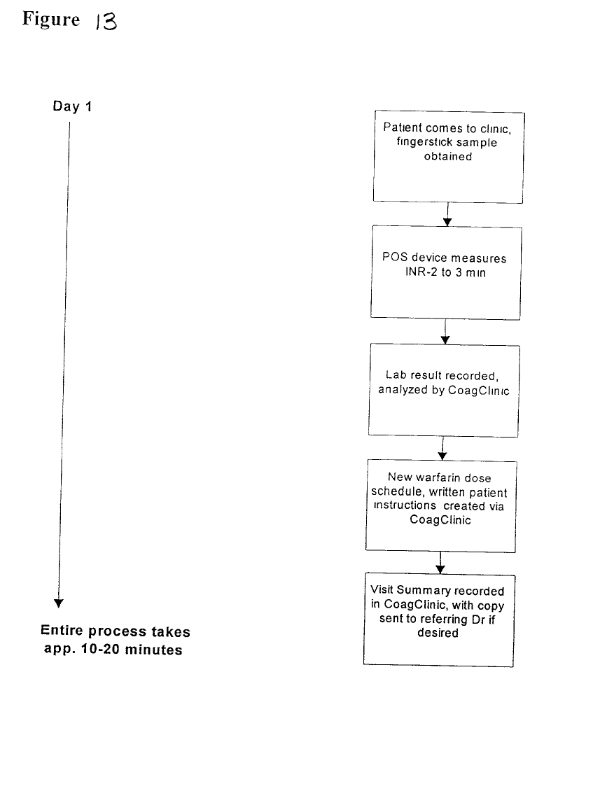

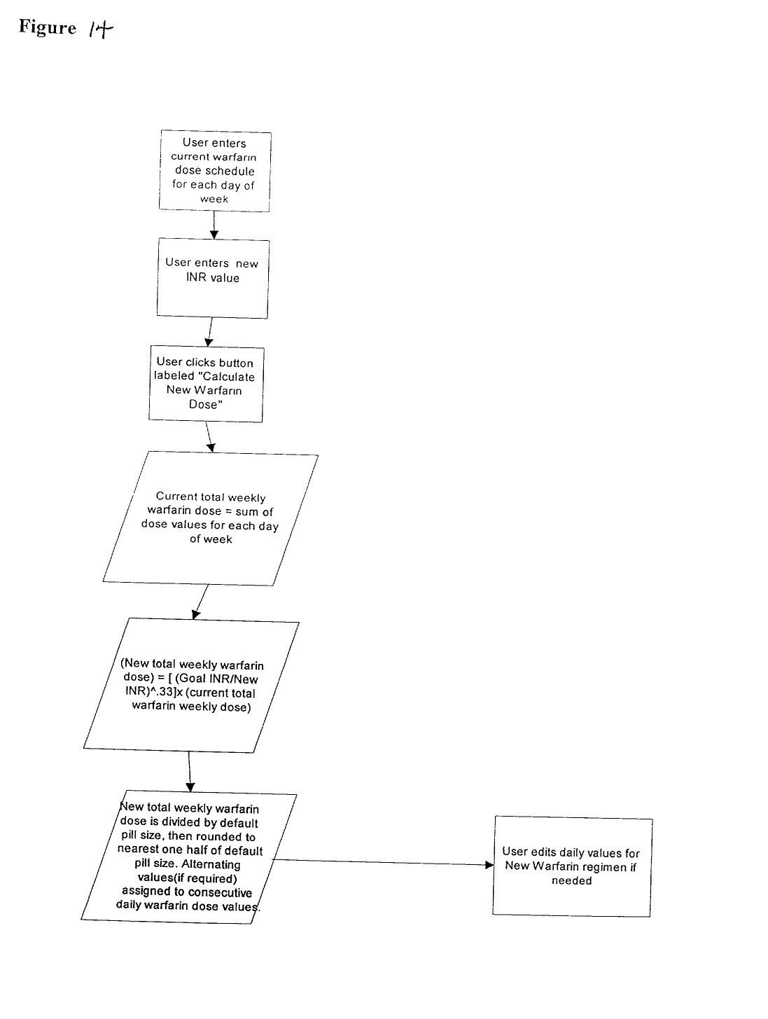

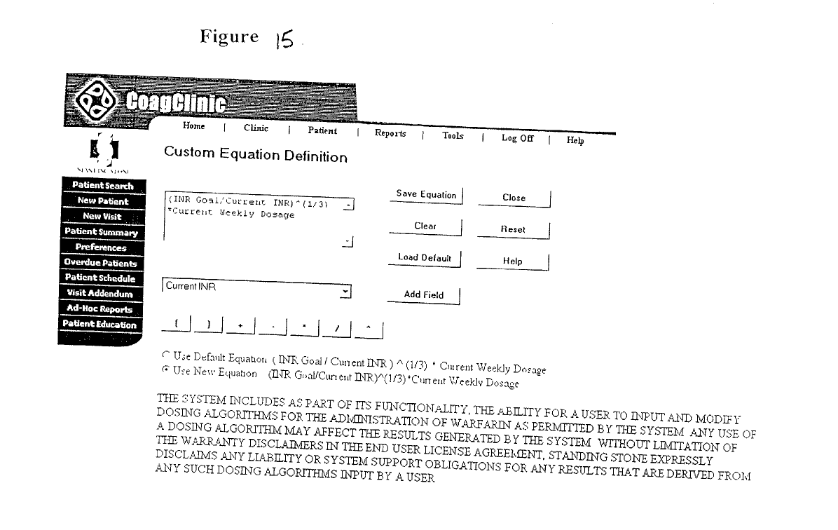

In FIG. 6, the “Report” menu provides access to standard and customized reports of clinic and patient activity. By way of example, FIG. 6 provides the following report options: “Patient Summary”, “Physician Summary”, “Clinic Summary”, and “Ad-Hoc”. The “Patient Summary” report identifies clinic activity with respect to a specific patient from a dropdown menu. Calendars are available to select the start and stop dates for the search. Data generated in this report includes demographic information on the selected patient and the referring physician, clinic visits with INR results and total warfarin weekly dosages, scheduled return dates, total number of clinic visits, and the patient's INR compliance rate for the period in question. Another similar report is a “Physician Summary” report that provides clinic activity with respect to a specific physician. Data generated in this report includes demographic information on patients referred by the selected physician, as well as the number of visits for these patients and the estimated clinic revenue thereby generated. The percentage of visits where the measured INR is in the desired range is also preferably provided for the selected physician. Yet another report option is for a Clinic Summary that records overall clinic activity including the number and identity of enrolled patients, the percentage of visits where the measured INR is in the desired range, the total number of patient visits, and the estimated revenue generated by clinic activities. All reports can be customized with respect to information over a specified period of time.

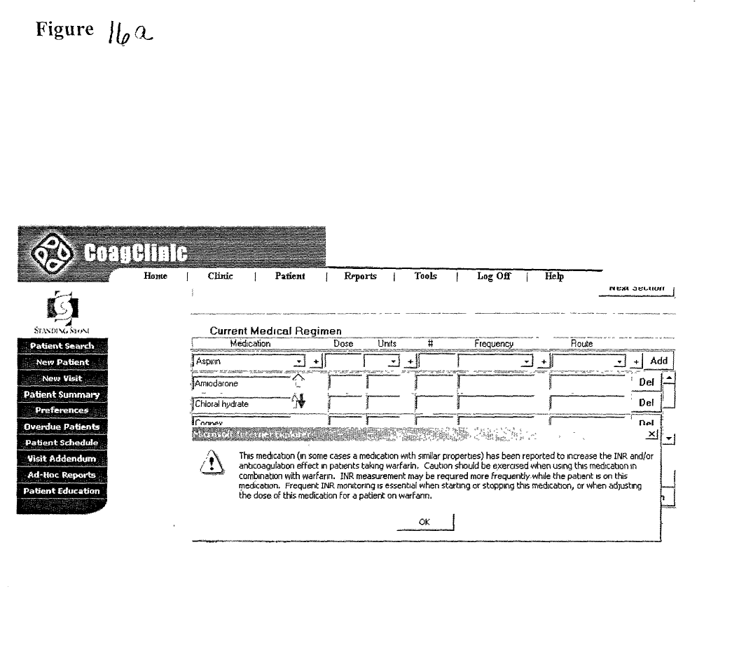

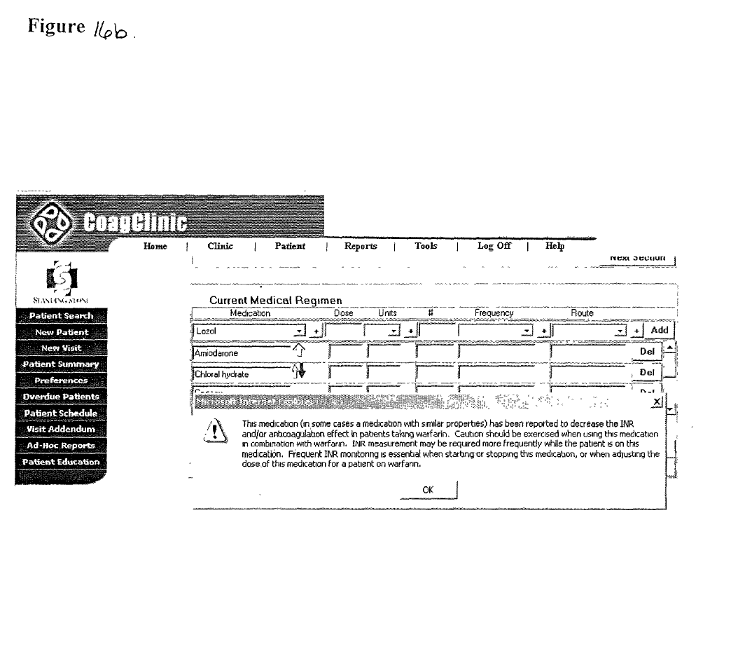

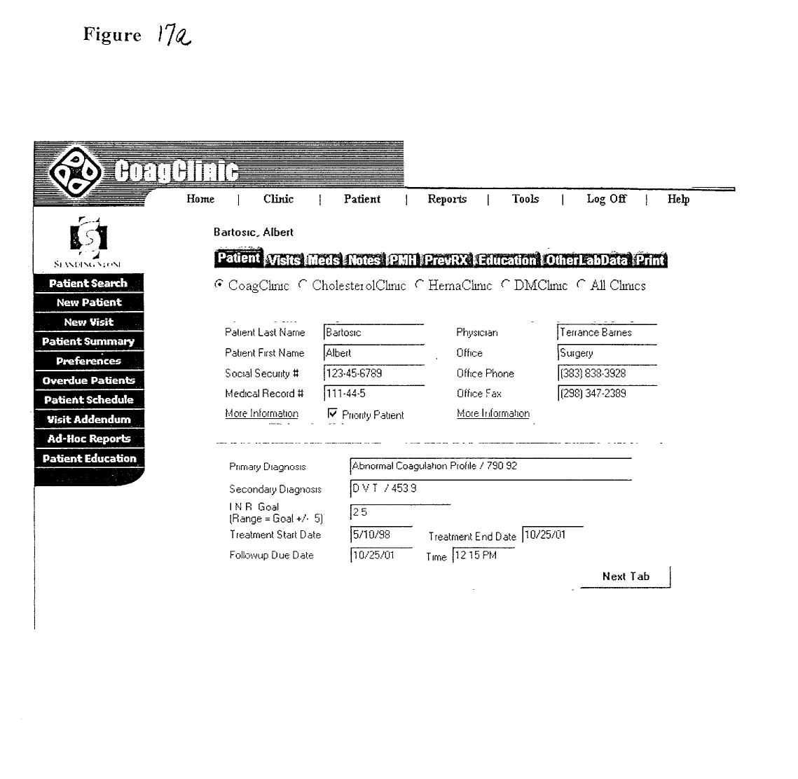

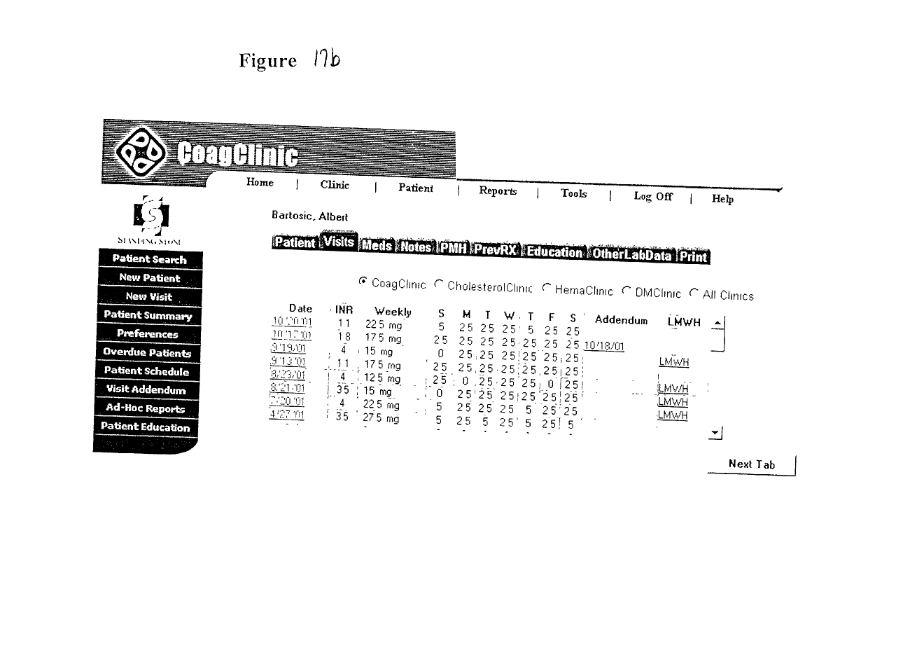

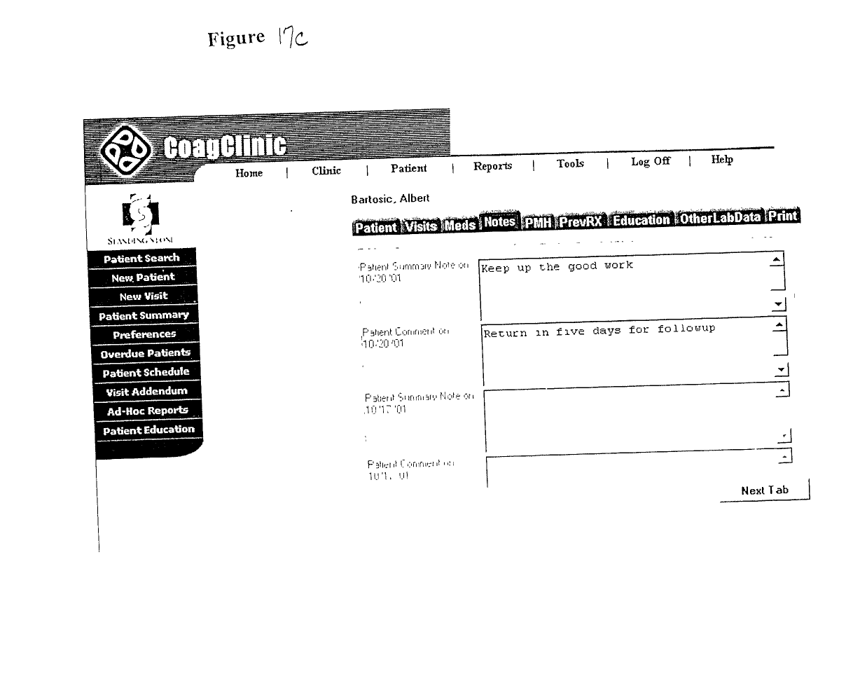

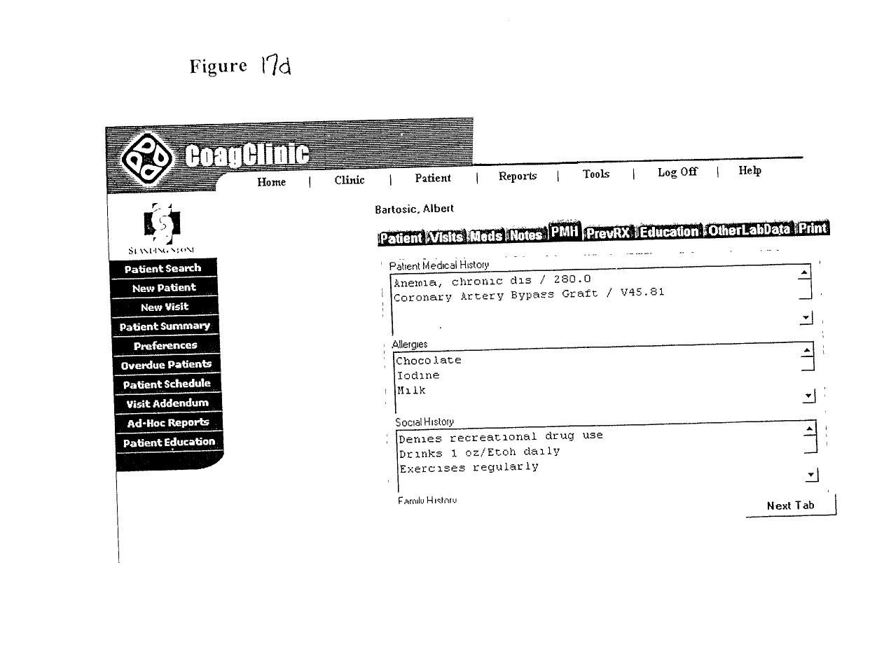

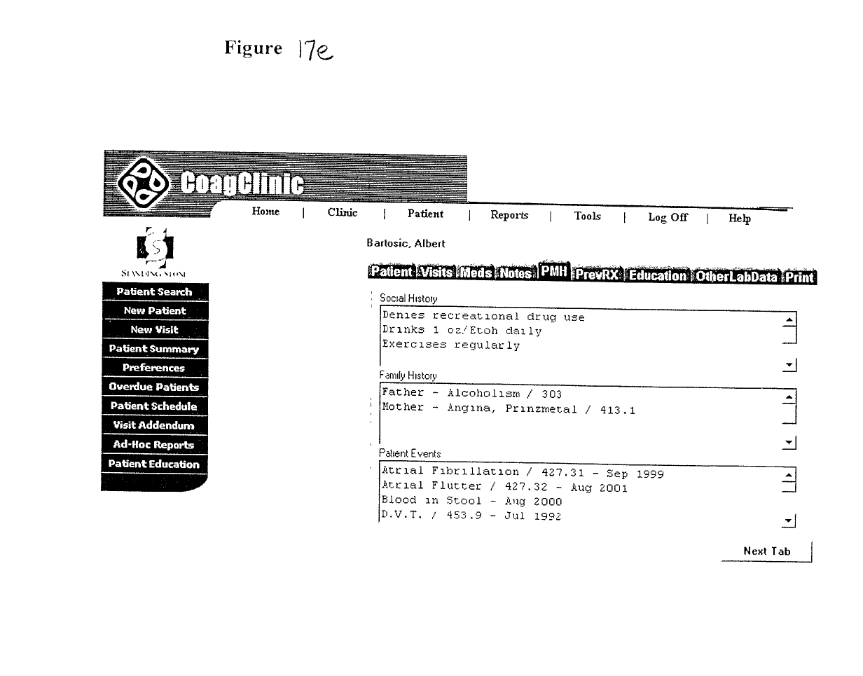

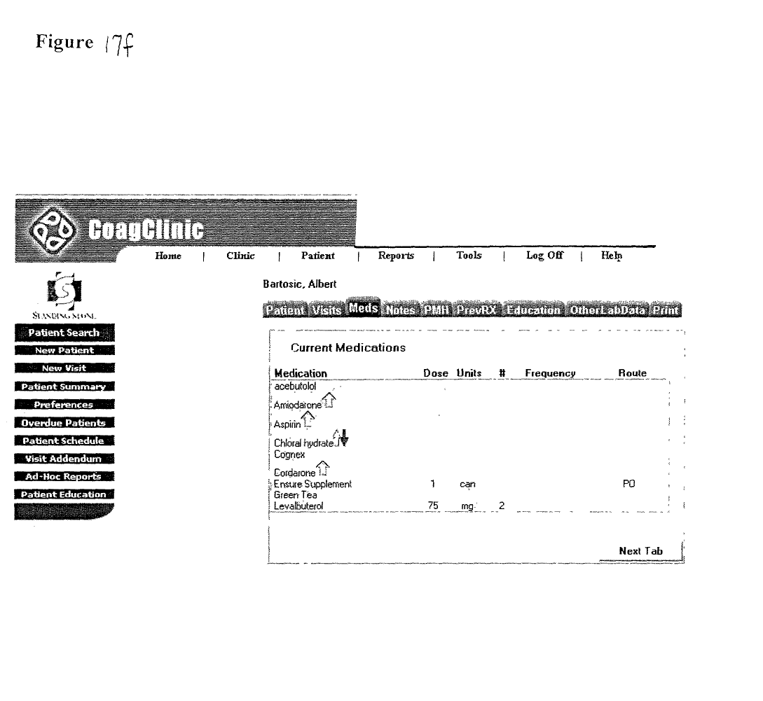

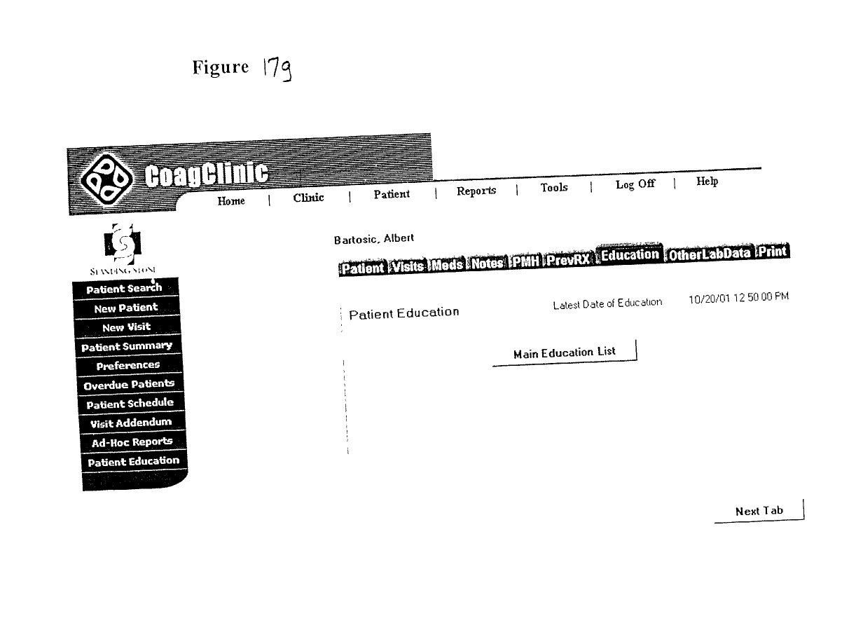

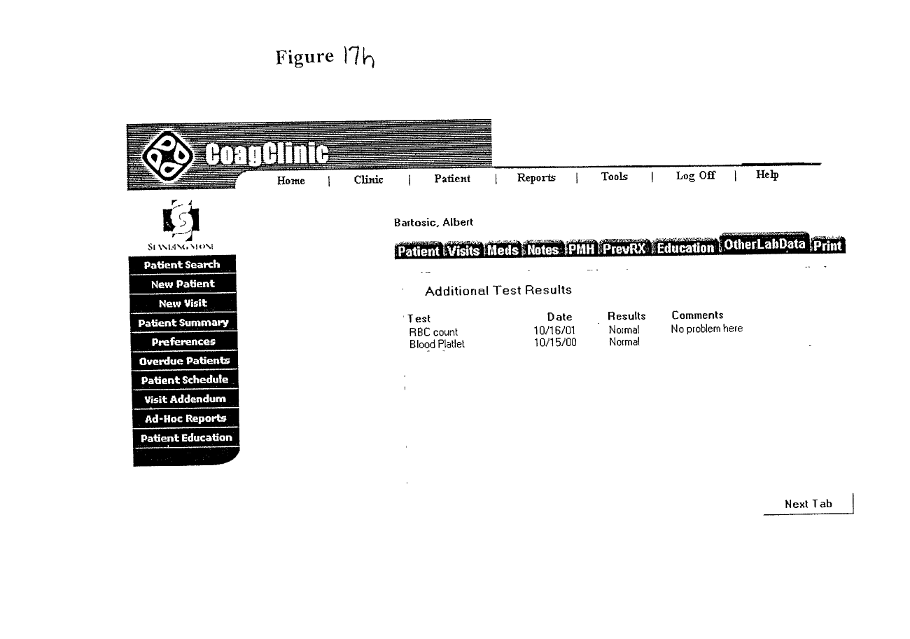

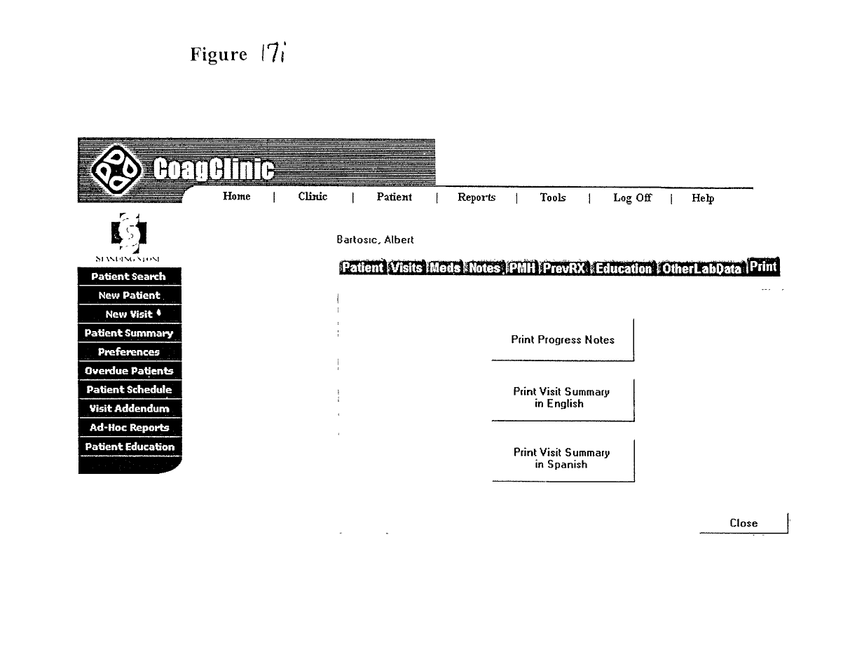

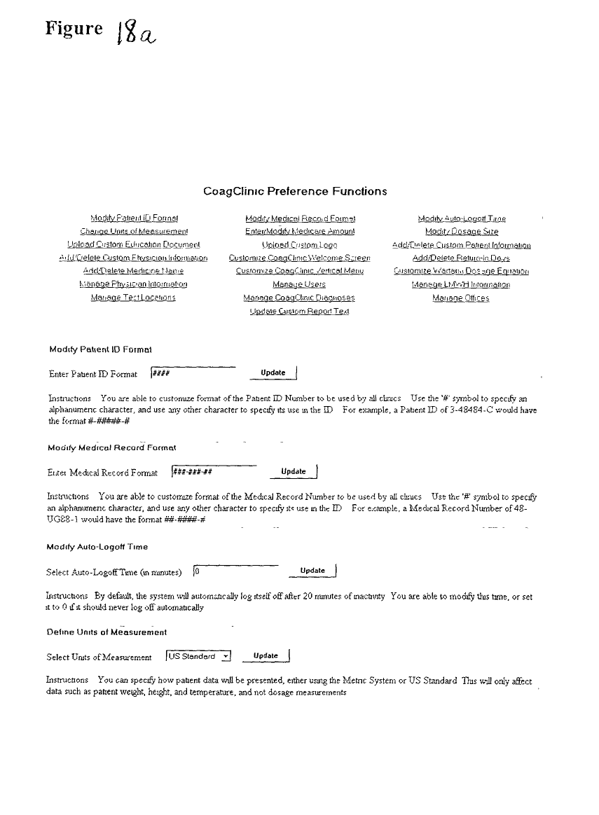

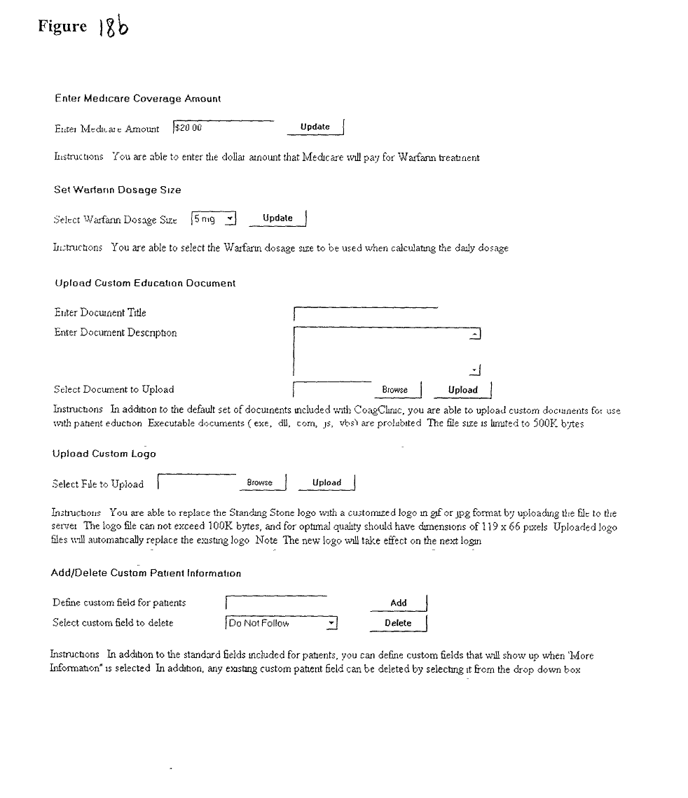

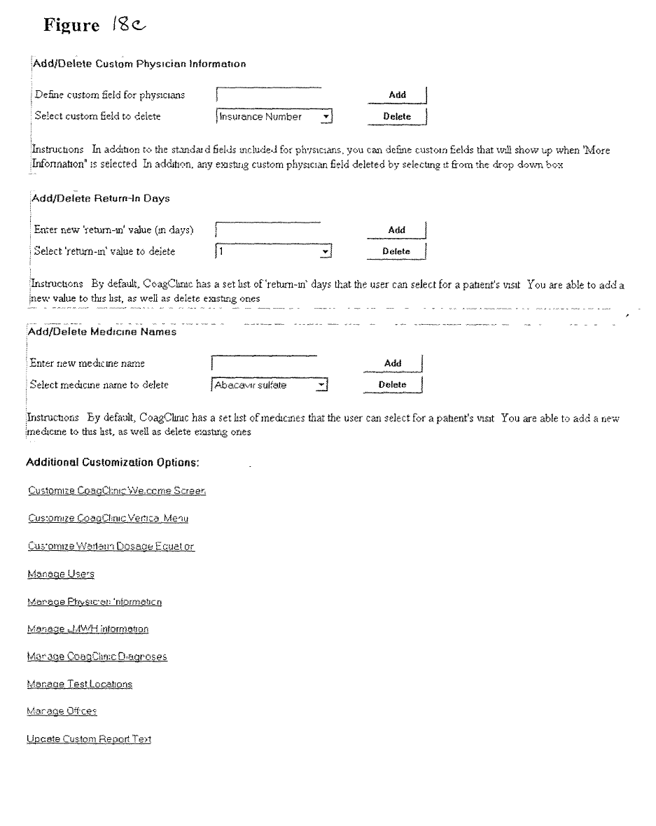

Complete report customization is provided with the “Ad-Hoc” option. This feature allows the user to generate a customized report by selecting a combination of fields and criteria. This tool/report is completely customizable for a given user and provides heretofore unavailable functionality from an integration application specific to this subspecialty area. FIGS. 7a-7g provide a plurality of exemplary screen shots for the “Ad-Hoc” search page. In response to selecting the “Ad-Hoc” option from the “Report” menu of the Home page an “Ad-Hoc” search page, as shown for example in FIG. 7a, is generated. The Ad-Hoc search provides seven different searching options: “Fields”, “User Data”, “Criteria”, “Sorting”, “Grouping”, “Stored Reports”, and “My Reports”. The “Fields” tab is the default tab displayer when the user activates the “Ad-Hoc” search page. A series of clinics are displayed along the top of the page from which the user may select a particular clinic. Appropriate information is automatically populated in the Category and Field boxes in response to the selection of the clinic. The user is able to add fields to the report by selecting a “Category” and “Field Name” for that “Category” and clicking on the “Add” button. That field is then added to the list in the area at the top of the tab page. A row may be deleted from the list by selecting the entry to be deleted and clicking the “Delete” icon. The report type area allows the user to specify how the information is to be presented. A Standard report returns the fields that were selected by the user. A Summary report returns only the number of records returned by the query.

The “User Data” tab (FIG. 7b) allows users to enter specific information to be displayed on the generated report. In addition, the user can specify an optional report title that will be displayed on the first page of the report. This title is not the same as the report name specified when a report is saved. A data entry field is also provided in which the user can specify footer text that will be displayed at the end of the report. This text is optional, and will be displayed after the last record in the report.

The “Criteria” tab (FIG. 7c) allows users to specify the criteria used to filter fields in the report. In order to specify a criterion, the user must complete all three sections. The first section is the Category and Field name. Depending on the Category selected, a list of corresponding Field names is displayed from which the user selects the Field to be filtered. The second item to be selected is the Condition. Condition parameters vary based on the type of data field selected. The final item is the Value. If a set of corresponding values are associated with a selected Field the values are displayed from among which the user may choose a specific list value. However, if a set of values does not exist, a text box is displayed to prompt the user to enter a specific data value. Items having the same Field name will be evaluated using logical “OR” operation, otherwise criteria will be evaluated using a logical “AND” connector.

Users are able to sort the Fields to their particular needs. The “Sorting” tab (FIG. 7d) displays a list of Categories for the Fields that are available. Depending on the Category selected, a list of corresponding Fields is displayed, with the user selecting the Field to be sorted and the order (ascending, descending).

“Grouping” tab (FIG. 7e) allows users to specify how the Fields in the report are to be grouped together. The tab displays a list of Categories for the Fields that are available. Depending on the Category selected, a list of corresponding Fields is displayed from which the user selects the field to be grouped and the order (ascending, descending).

By identifying a Field to be grouped the report will display records together that have the same value for the selected Fields. Having multiple fields selected will group the records by the first Field, and each group will have a sub-group according to the next Field selected. For example, the user could group report date first by Visit Date, then by Gender within the Visit Date group.

The “Stored Report” tab (FIG. 7f) allows the user to select a preexisting report. This report can either be run based on the information stored in memory or may be modified before being run. If the user saves a customized report it will not be saved under the “My Report” tab, not the “Stored Report” tab. The “My Report” tab provides a list of reports that have been previously saved by a user for the subscriber. These saved reports are visible to all users within the same subscriber. The selected report can either be run based on the information stored in memory or may be modified before being run. After retrieving a report, the Fields tab will be displayed with the report's information displayed.

FIG. 8 shows an exemplary screen in which the “Tools” menu has been activated to show the “Preferences” option. This option is available only to system administrators who have been granted appropriate access privileges. The “Preference” page of options generated by the user provides a table of configuration options that the user may select to customize the web site, as desired. The “Log Off” and “Help” menus are conventional in that they are used to sign off of the web site and to access help files.

FIGS. 9a-9f show exemplary “New Visit” screens for recording information during a patient's visit. The screen is generated by the server in response to the user selecting the “New Visit” option from the dropdown list associated with the “Patient” menu or selecting the appropriate option from the tool bar on the left hand side in FIG. 2. The screen shots shown in FIGS. 9a-9f can be represented by a single web page or multiple web pages. Recording a patient visit involves entering or editing information in a series of data fields. While information can be entered in many fields in any order, the fields are preferably arranged in a sequence that helps to ensure the important items are included. In this way, the “New Visit” screens provides a worksheet to assist the user in the comprehensiveness of medical issues addressed during a visit. In addition, payment for services from government and private insurance companies requires predetermined medical documentation generally based on professional requirements promulgated by Medicare and adopted by primary insurers. By completing the fields in the “New Visit” screens, the user ensures compliance with these standards and facilitates payment for services rendered.

The user can navigate between fields by using the mouse or by using the TAB key. Use of the Tab key is advantageous in that it steps through each field in sequential order thereby improving the comprehensiveness of the information. The “New Visit” screen is divided into sections, each with its own associated “Help” button to provide step-by-step instructions pertinent to that particular section.

The first section of the “New Visit” screen provides preliminary identifying information arranged in a plurality of data entry fields to be completed by the user. Each field is preferably formatted for the data expected in the field. If the user enters data that is inappropriate for the field, they will be prompted to correct the entry. In the exemplary embodiment shown in FIG. 9a, the first section includes data entry fields to enter the last and first name of the patient, Social Security number, medical record number, patient's physician (either the patient's primary care physician or a referring physician), office of the patient's physician, and office telephone number and facsimile number for the patient's physician. If the patient has already been enrolled in the clinic, the first and last name are automatically populated in the appropriate data entry fields. The information can be edited if necessary. For a new patient, these fields will be blank. The user simply types in the necessary information, or selects from the dropdown list (if available).

The next section of the “New Visit” page prompts the user to enter additional information . “Primary diagnosis” field prompts the user to enter the patient's primary diagnosis and the associated International Classification of Disease (ICD) code for that diagnosis. Usually, this diagnosis is the primary reason for placing a patient on anticoagulation therapy. The diagnosis can be selected from the available drop-down list. Otherwise, the user can type a new entry into the data entry field after clicking on the “+” button adjacent to the “Primary Diagnosis” field. In response thereto, the server will generate a prompt for the user to enter the desired information. Clicking on the button labeled “OK” after entering the information in the field will store the value for the active patient. Clicking the button labeled “Cancel” will close the dialog.

Another data entry field is provided to display the name of the patient's secondary diagnosis and associated ICD code for that diagnosis. This diagnosis may be related to the reason for placing a patient on anticoagulation therapy or may represent another diagnosis considered noteworthy by the physician. Depending upon the needs of each clinic this field may be left blank. Similar to that of the primary diagnosis, the secondary diagnosis can be selected from the available drop-down list or can be entered directly by typing in the field following similar steps.

“INR goal” field displays the patient's INR goal. In the example provided in FIG. 9a, the goal has a range of +/−0.5 on either side of the set value. Typically, the INR goal is either 2.5 or 3.0. Nonetheless, the INR goal can be outside this range, such as from 1 to 4 or any other range which is currently or hereinafter determined to be medically feasible. In addition, clinical circumstances or clinic preferences may dictate that another INR goal be used. The user can select the appropriate value from the dropdown list or type in a specified value.

The “Follow-up due” field displays the follow-up due date for the active patient that was entered at the time of the patient's last visit. This is presented here for informational purposes and does not require a new entry. The user is offered an opportunity to enter a new follow-up due date in a later section on this page described further below.

The data field “Patient Events” is used to record a history of past medical events that are either a direct result of anticoagulation therapy or have a direct impact on administering such therapy. The data in this field may be edited by the user. To add a new problem or diagnosis the user selects from the list labeled “Available Events” or enters the information after clicking on the “+” button. The month and year of the date of the event are selected from the appropriate boxes. Once the user is satisfied with the identity and date of the event the user can click on the button labeled “Add” in order to record the event. If the information contained is too extensive to display on one screen a scrollbar will appear on the right border of the field. Clicking on the button labeled “Del” for an existing entry will remove that entry from the list of “Patient events”. If another value for the “Patient Events” field is desired the user can click on the small tab labeled “+” adjacent to the “Patient Events” field. Doing so will display a prompt in which the user may enter the desired value. Clicking on the button labeled “OK” will store the value for the active patient. Clicking the button labeled “Cancel” will close the dialog. The server updates the screen to the next section of the “New Visit” page in response to the user clicking on the “Next Section” button. Alternatively, the user can use the TAB key to advance to the next field.

An exemplary third section of the “New Visit” page is shown in FIG. 9b. This section prompts the user to enter data for the current visit including the date of the visit. Usually, the date of the visit will coincide with the current date. For convenience, this field will therefore default to the current date. However, this field can be changed to another date, for instance, if a lab result sent to the clinic has been delayed for some reason. Additional information entered by the user includes: the patient's vital signs, test location of the laboratory results, visit type, whether the patient is currently on LMWH therapy, warfarin type, most recent warfarin dose schedule, current INR and Protime results. In order to comply with documentation requirements for payment for services rendered under Medicare, the user should record results for at least three of the five available vital sign fields. However, where information for particular fields is not available, e.g., where the patient is providing information by telephone rather than in person, the fields which require a current reading need not be completed. In this event, only information which is available to the user is entered. The Protime field is optional and has been included for historical purposes and for those clinics that may require this field. Entering a new INR result preferably automatically displays a message box showing the ACCP guidelines for correction of an abnormal INR if the result warrants action. FIG. 11 shows an exemplary flow chart for the entry of an INR value and the resulting feedback message.

Referring once again to FIG. 9b, the “Current Warfarin Regimen” is represented by a series of eight fields that is automatically populated with the patient's most recent warfarin dose schedule for every day of the week and a total weekly dosage. It may be necessary to edit the daily dose fields to reflect recent dose changes or skipped doses. The “Total/Wk” field is automatically calculated based on the total values of the daily dose fields for the week and is not editable. In a preferred embodiment, each field specifies the exact dose prescribed in milligrams. However, the system in accordance with the invention could be modified to reflect the number of pills taken.

Heretofore, the calculation and prescription of a new warfarin dose required a patient visit and a test which was analyzed by a laboratory. The physician would schedule a visit with the patient to discuss the results and new dose regimen. A conventional anticoagulation therapy workflow is shown in FIG. 12. This process was inefficient in that scheduling and processing by labs resulted in delays. Because each encounter required venipuncture, physician time and scheduling of additional visits, the medical costs associated therewith are high for which physicians receive only minimal reimbursement. In addition, patient counseling and medication instructions are provided without oversight, written instructions, prospective procedural follow-up visits and adequate standardized documentation. These and other factors result in greater chance for errors producing a higher medical liability risk.

In a preferred embodiment of the present invention, the patient test, results and prescription are accomplished during a single office visit. FIG. 13 is an exemplary anticoagulation therapy workflow diagram in accordance with the present invention. This system is advantageous for both the patient and the caregiver. Patients benefit in the following ways: decreased risk of complications, face-to-face contact with caregiver, increased access to educational information, enhanced emotional support, more efficient turn around time, decreased number of scheduling, elimination of venipuncture, and improved patient compliance with therapy regime. The system is also beneficial to the caregiver by increasing revenues, decreasing complications and associated costs, more efficient turn around time, decreasing overhead, decreasing scheduling of appointments, and allowing for tracking of outcome and analysis.

Another problem with traditional methods of prescribing a new warfarin dose is the complexity of accurately providing a daily dose based on a variety of pill sizes and converting a weekly dose to a daily dose. This is described further under the New Warfarin Regimen below. Clicking on this button will display a suggested dosage as calculated using the selected decision support algorithm. The raw output of the calculation is then compared against the default pill size selected by the user and translated into a seven day dosing regimen as described further under the New Warfarin Regimen below.

FIG. 14 shows an exemplary processing flow for the dosing algorithm as well as its implementation in accordance with the present invention. The dosing algorithm can be modified in the “Custom Equation Definition” page shown in FIG. 15. This screen is generated by the server in response to the user selecting the “Customize Warfarin Dosage Equation” on the “Preference” pages of FIGS. 18a-18c.

Referring once again to the “New Visit” page in FIG. 9b, after entering the information a new warfarin dose is automatically calculated in response to the user clicking on the “Calculate New Warfarin Dose” icon. The adjusted values are automatically populated under the “New Warfarin Regime” heading in their respective data entry fields representing the different days of the week as a result of the automatic dose schedule calculation. Alternatively, each dosage may be manually entered into the new dose schedule. Each daily dose field can be edited. The “Total/Wk” field automatically calculates the total of the values of the daily dose fields for the week and is not editable.

There are numerous varieties of warfarin medications. The number of milligrams per pill varies depending upon the variety of warfarin medication. As a result, patient confusion may occur when a doctor prescribes a number for the prescription as to whether the number relates to the number of pills or the number of milligrams. Therefore, patients sometimes mistakenly take the wrong quantity of a medication. Compounding this problem is the fact that the warfarin dose is generally calculated on a weekly basis and then divided into a daily dose. As a result, errors sometimes occur in the arithmetic conversion. The present invention reduces such problems by providing a result for a new warfarin regimen consisting of a dose per day in milligrams. In addition, this milligram quantity is based on a particular medication milligram amount selected by the user in the “Preferences” page of the web site. This feature can be activated by selecting the “Modify Dosage Size” option in the “Preferences” page shown in FIGS. 18a-18c and described further regarding that figure. This results in less errors both in consistently providing the prescription in milligrams to patients and reducing potential arithmetic error. In addition, where the medication is changed, the “Preferences” page can be used to record the new medication for use in the calculation. In addition, the Dosage Size may be modified for a particular patient as shown in FIG. 9b. To avoid potential confusion, each field specifies the exact dose prescribed in milligrams. The warning displayed on the screen states that each field displays the dose in milligrams, and not the number of pills to be taken.

The new warfarin dosage is determined by a mathematical probability calculation based on the patient's current total weekly warfarin dose, current INR, and INR goal in order to derive an estimation of the patient's new total weekly warfarin dose requirement. The software application will then convert the total weekly dose to a convenient daily schedule that utilizes the clinic's preferred warfarin pill size preselected by the user in the “Preferences” page by selecting the “Modify Dosage Size” option, described further below.

Selecting the “Customize Warfarin Dosage Equation” option from the “Preferences” page (FIGS. 18a-18c) invokes the server to generate a new page, shown in FIG. 15, that allows the user to customize a number of settings with respect to the dosing algorithm. The default equation is shown. A new equation can be substituted by deleting all or part of the current equation and entering an eligible field(s) with mathematical operator(s), as needed. Once entered, pressing the button labeled “Save Equation” will set the current equation as the active equation. The “Clear” icon erases the current equation from the window, “Load Default” reloads the original default equation into the window, “Add Field” enters the selected eligible data field into the active equation in the window, and “Close” returns the user to the previous screen.

Referring again to the “New Visit” page in FIG. 9b, the “ACCP Guidelines” button when selected activates the server to open a new browser window highlighting a Quick Reference section for the current version of ACCP anticoagulation guidelines.

Three check boxes at the top of the next section of the “New Visit” page reflect patient instructions regarding questions about medications, nutritional and dietary concerns, as well as instructions to the patient to monitor for excessive bruising or bleeding. The “Progress Notes” and “Comments for Patient” data entry fields contain data noteworthy by the clinic. These fields can be customized from the list of options provided in the “Preferences” pages (FIGS. 18a-18c).

Referring to FIG. 9b, a “Return in ______ days” data entry field is used to specify how soon and when a patient should return for a follow-up visit. If the patient's warfarin dose schedule has been changed during this visit, the user will be prompted to consider a return visit in several days. If there is no change in the patient's warfarin dose schedule, the user will be shown a message that a longer duration between the current and next visits may be appropriate. When the user decides how many days should elapse until the next appointment, the server will calculate the next business day that a follow-up visit can be scheduled, given the date of the current visit and the desired interval. This date will appear in the data field labeled “Visit Due Date”, and can be edited as needed. An interactive calendar useful to schedule the next visit may be displayed in response to the user selecting the “Calendar” icon. In addition, if patients are already scheduled for a particular time on the selected return visit date, the system will automatically highlight those times so as to further assist with patient scheduling.

FIG. 9c shows an exemplary “Current Medical Regimen” section of the “New Visit” page. If the patient has had a previous visit during which the medical regimen was recorded, this table will show the most recent entries. The user can change, eliminate or add medications to the patient's current medical regimen. Each medication field contains the name (generic or brandname) of one medication part of the patient's current therapy. The system displays interactive warnings (audio, written, and/or visual) regarding potential warfarin drug interactions depending on the medication chosen. Examples of such interactive warnings are shown in the message boxes based on the medications are shown in FIGS. 16a & 16b. The warnings are based on professional standards from the Physician's Desk Reference.

For each medication listed in the “Current Medical Regimen” section of the “New Visit” page in FIG. 9c, the user enters current dose size, appropriate unit by which the medication dose is measured, number of doses of the medication (represented by the symbol “#”), frequency medication is given, and route of administration of the medication to the patient. An exemplary medication listing is as follows:

| Example - medication | dose | units | # | frequency | route |
|---|---|---|---|---|---|
| Tylenol | 325 | mg | 2 | q 6 hours | P.O. |

The next section of the “New Visit” page provides a plurality of data entry fields for the user to review, delete, add, and edit a history of information entered during previous visits regarding the patient's past “Medical History”, “Allergies”, “Family History”, and “Social History”. The data in these fields is fully editable. To add a new entry, the user may select from the dropdown list to the right of the associated data entry field or type in the information. Once the user is satisfied with the information entered, clicking on the button labeled “Add” will record the event. If another entry is desired, the user can click on the small tab labeled “+” adjacent to the respective field. Doing so will display a prompt in which the user may enter the desired information. If the information contained is too extensive to display on one screen a scrollbar will appear on the right border of the field. Clicking on the button labeled “Del” for an existing entry will remove that entry from the list.

The additional sections of the “New Visit” page are shown in FIG. 9d and include a “Patient Education Checklist” section that assists the user with initial and periodic educational interaction with patients receiving anticoagulation therapy. The frequency with which this is used may vary by system or clinic. “Date of Education” data field, by default, displays the date of use of the product, but can be edited as needed. This field documents the teaching session for future reference. The “Main Education List” icon provides a complete list of fundamental teaching points to be covered. Checking the box associated with each teaching point serves to document that the point was covered. Each teaching point also has an associated “?” button that displays details regarding that particular teaching point to help ensure completeness and accuracy. Additional documents related to anticoagulation therapy may be selected by the user from the dropdown list of “Other Documents”. Once selected, the document will be displayed with associated controls to allow the document to be printed.

“Additional Test Results” of outside or unrelated laboratory results are entered in the next section of the “New Visit” page. For each result, the user enters the name of the test, the date the test was performed, the test results, and any further comments regarding the test.

In response to clicking on the “Low Molecular Weight Heparin” icon a new window is displayed (FIG. 9e) to access a module to assist with administration of Low Molecular Weight Heparin. FIG. 9e is an exemplary screen to assist the user with the administration of LMWH preparations. The icon “Hide LMW Heparin” when selected by the user causes the server to close the screen and return to the “new Visit” screen in FIG. 9d. A series of pull down menus are provided in series. The first option prompts the user to select a “Reason for LMW Heparin administration”. A plurality of options are provided in a dropdown list from which the user may select the appropriate indication for LMWH administration in the active patient. The user either selects from the available choices or enters a new indication, if needed. In a preferred embodiment, the dropdown list, by default, contains the current FDA approved indications for LMWH therapy. Selecting a choice from the default list of “Reasons for LMW Heparin administration” will automatically populate the “Desired intensity of anticoagulation” therapy and “Desired LMWH preparation” data entry fields with FDA recommended values.

The “Desired intensity of anticoagulation” field contains a dropdown list from which the user may select the desired level of intensity for anticoagulation therapy. The default choices are prophylaxis and full anticoagulation. If one of the default choices from the “Reason for LMW Heparin administration” field has been selected, a suggested intensity of therapy will automatically be provided. The “Desired LMW Heparin preparation” is likewise preferably a dropdown field. If one of the default choices from the “Reason for LMW Heparin administration” field is selected by the user, FDA recommended LMWH preparations will automatically be provided by default and may be changed by the user, if needed. In addition, the user is prompted to specify the “Anticipated duration of LMW therapy” in the appropriate data field. The user may choose from one of the default selections or enter another duration, as necessary.

Table 1 below is a chart based on FDA approved indications of the recommended “Desired intensity of anticoagulation”, “Desired LMW Heparin preparation” and “Anticipated duration of LMW therapy” for each “Reason for LMW Heparin administration” listed in the default dropdown field.

TABLE 1

| | Desired intensity | | |
|---|---|---|---|
| Reason for LMW Heparin administration | of anticoagulation | Desired LMW Heparin preparation | Anticipated duration of LMW therapy |
| Bridge therapy for chronic anticoagulation | Full Anticoagulation | Enoxaparin | 3 days, 7 days, 14 days, 21 days, other |
| Chronic Anticoagulation Therapy | Full Anticoagulation | Enoxaparin | 3 days, 7 days, 14 days, 21 days, other |
| Initiation Of Anticoagulation Therapy | Full Anticoagulation | Enoxaparin | 3 days, 7 days, 14 days, 21 days, other |
| Prophylaxis of Dvt | Prophylaxis | Enoxaparin, Dalteparin | 3 days, 7 days, 14 days, 21 days, other |
| Prophylaxis of Dvt-abd Surgery | Prophylaxis | Enoxaparin, Dalteparin | 3 days, 7 days, 14 days, 21 days, other |
| Prophylaxis of Dvt-hp replacement | Prophylaxis | Enoxaparin, Dalteparin | 3 days, 7 days, 14 days, 21 days, other |
| Prophylaxis of Dvt-knee Replacement | Prophylaxis | Enoxaparin, Dalteparin | 3 days, 7 days, 14 days, 21 days, other |
| Unstable Angina | Full Anticoagulation | Enoxaparin | 3 days, 7 days, 14 days, 21 days, other |

After completing the aforementioned fields, the user is prompted to provide the patient's weight. If the patient's weight was recorded in the vital signs section in the “New Visit” page, this field would automatically be populated with that same value and converted from pounds to kilograms, if needed. The Anti Xa level may be requested to assist with LMWH dosing.

The time interval between LMW heparin administration and laboratory sample collection is to be entered in the field “Test performed ______ hours after last heparin dose”. Additional information prompted to be entered by the user includes “Creatinine” level and “Date done” (date on which the laboratory assay was performed).

After the preliminary information and laboratory levels have been entered, in response to the user clicking on the “Calculate Regimen” icon, the server generates a possible prescription for LMWH for the active patient based on the patients current weight, “reason for LMW Heparin administration”, and “Desired LMW Heparin preparation”. FIGS. 10a-10d show an exemplary decision flow chart for the administration of LMWH in accordance with the present invention. In one embodiment of the present invention, the LMWH regimen is determined based on the three data entry fields. However, in alternative embodiments, fewer than the three fields can be used where a medically feasible regimen can be calculated. The generated prescription can be changed by the user if needed.

The “Medication” field automatically records the name of the medication to be administered based on the user's selection from the “Desired intensity of anticoagulation” field. To the right of the “Medication” field is a “Dose” field which automatically records the dose of the medication to be administered based on the calculation, the “Frequency” field records the frequency of administration of the medication to be administered based on the calculation, and a “Notes” field in which the user can enter notes and/or comments. The contents of any of these fields can be changed by the user if needed.

Below these data entry fields is a series of checkboxes that provide a means by which the user can document patient education and informed consent regarding LMWH administration. At the lower right hand corner of the screen are three icons: the “LMW Heparin information” button provides a hyperlink to web based information on LMWH, “Help” provides access to help files, and “Next Section” causes the server to generate the next section of the “New Visit” page. Alternatively, the user can use the TAB key to advance to the next field.

FIG. 9f shows an exemplary screen of the final section of the “New Visit” page that is used to document the health care provider of record and save the visit data to the database. To sign the record, the user types in their assigned user name in the data field labeled “Login ID”. Preferably, the user name will be identical to the ID utilized to log on to the web site. In the data field labeled “Password”, the user enters their password that is preferably identical to the password utilized to log on to the program. The name of the “Supervising Physician” who supervises the Anticoagulation clinic is selected from the available dropdown list. Data entered for the active patient's visit is recorded in response to clicking on the “Save” button and the server automatically displays the “Home” page.

FIGS. 17a-17i depict exemplary “Tab View” pages for a particular patient. A series of tabs are shown in FIG. 13b to advance through the different “New Visit” pages. The exemplary embodiment shown in FIG. 13b includes the following tabs: “Patient”, “Visits”, “Meds”, “Notes”, “PMH” (Patient Medical History), “PrevRX” (Previous Medications), “Education”, “Other Lab Data”, and “Print”. The “Patient” tab advances to a “New Visit” page (FIG. 17a) containing patient and physician demographic information, primary and secondary diagnoses, INR goal, and scheduled date of follow-up visit. “Visits” tab advances to a page (FIG. 17b) that provides a summary of past visits, highlighting visit dates, INR results, warfarin doses, and addendum. Clicking on one of the color-coded visit entries will bring up a screen showing further details of that visit, including vital signs, the most recent warfarin schedule prior to the visit date in question, the new warfarin schedule given on the day of the visit, as well as the Protime and INR results. A display of a patient's current medications (other than warfarin, which is summarized in a New Visit session) can be viewed by selecting the “Meds” tab. The “Notes” tab displays prior progress note entries (FIG. 17c). Information regarding the active patient's past medical history, allergy history, family history, and social history is displayed by clicking the “PMH” tab (FIGS. 17d & 17e). Prior medication regimens are shown in response to selecting the “Prev RX” tab (FIG. 17f). A record of prior sessions of patient education regarding anticoagulation therapy and contents of important teaching points may be readily viewed by selecting the “Education” tab (FIG. 17g). Previously entered laboratory results (other than INR or Protimes, which are recorded in a New Visit) are displayed in response to selecting the “Other Lab Data” tab (FIG. 17h). The “Print” tab provides the user the option to print a “Progress Notes” report or “Visit Summary” report (in either English or a foreign language) (FIG. 17i).

The anticoagulation therapy system in accordance with the present invention is customizable in that it includes “Preference” screens from which the user is provided with a list of Preference functions. This page is accessed by selecting the “Preferences” option on the “Tools” menu of the “Home” page in FIG. 2. The “Preference” page displays a list of customizable features. By way of example, the “Preference” page in FIGS. 18a-18c includes the following customizable options: “Modify Patient ID Format”, “Change Units of Measurement”, “Upload custom Education Document”, “Add/Delete Custom Physician Information”, “Add/Delete Medicine Name”, “Manage Physician Information”, “Manage Test Locations”, “Modify Medical Record Format”, “Enter/Modify Medicare Amount”, “Upload Custom Logo”, “Customize Welcome Screen”, “Customize Vertical Menu”, “Manage Users”, “Manage Diagnoses”, “Update Customer Report Text”, “Modify Auto-Logoff Time”, “Modify Dosage Size”, “Add/Delete Custom Patient Information”, “Add/Delete Return-In Days”, “Customize Warfarin Dosage Equation”, “Manage LMWH Information”, and “Manage Offices”. Below the table each option is displayed in sequential order and includes instructions on how to implement eligible changes. The user can proceed directly to a choice by clicking the appropriate entry in the table at the top of the page. Once a particular customized setting has been entered it is recorded in response to the user clicking on the associated “Update” button. Each option will now be discussed in detail.

“Modify Patient ID Format” allows the user to customize the format of the Patient ID Number to be used. This number may be different than the Medical Record Number depending on the health system (see Medical Record Number section). A ‘#’ symbol is used to represent an alphanumeric character and any other character is used to specify its use in the ID. For example, a Patient ID of 3-48484-C would have the format #-#####-#. “Modify Medical Record Format” is used to customize the format of the Medical Record Number to be used. This number may be different than the Patient ID Number, depending on the health system (see Patient ID Number section). Once again the ‘#’ symbol represents an alphanumeric character and any other character is used to specify its use in the ID. For example, a Patient ID of 3-48484-C would have the format #-#####-#. “Modify Auto-Logoff Time” sets the time period prior to log off. By default, the system preferably will automatically log itself off after 20 minutes of inactivity. You are able to modify this time, or set it to 0 to prevent the system from logging off automatically.

“Define Units of Measurement” allows the user to specify the system of measurement in which patient data will be presented, using either the Metric System or US Standard system. This will only affect data such as patient weight, height, and temperature; medication doses are not affected.

“Enter Medicare Coverage Amount” allows the user to change the monetary value that the application uses to calculate estimated clinic revenue. This value is used for internal calculations only, and will not affect the actual amounts billed to third party payers.

“Set Warfarin Dosage Size” provides a means for changing the default warfarin pill size that the clinic uses for dose calculations. This pill size will be used as the default pill size for all patients in the clinic but can be changed at the time of the visit as needed. “Upload Custom Education Document” allows the user, in addition to the default set of documents, to upload custom documents for use with patient education or other clinic needs. Executable documents (.exe, .dll, .com, js, .vbs) are prohibited. The file size can be limited to 500K bytes. In order to upload a document the name for the document by which it will be identified on the “Patient Education” page is entered along with a more detailed description of the document ,if desired, in the box immediately below. Use the button labeled “Browse” to open a file tree and locate the source file. Click the button labeled “Upload” to transfer a copy of the source file and make it available to the application.

“Upload Custom Logo” provides the user with the option of replacing a default logo with their own customized logo. This can be accomplished by uploading an image file (e.g., gif or jpg format) to the server. Preferably, the image file should not exceed 100K bytes in size and, for optimal quality, should have dimensions of 119×66 pixels. Uploaded logo files will automatically replace the existing default logo. “Browse” and “Upload” buttons are used in a conventional manner to locate and transfer the source file.

“Add/Delete Custom Patient Information” data field provides the user with the option of defining custom fields in addition to the default fields included for patient information. These fields are displayed by the server in response to the user selecting the “More Information” button from the appropriate page. To add a new custom field, the user enters the name of the field in the text box and clicks on the “Add” icon. Any customized field can later be removed by selecting the particular field and clicking on the “Delete” button.

“Add/Delete Custom Physician Information” allows the user to define customized fields in addition to the default fields included for physician information. The creation of this field is the same as that described above with respect to the “Add/Delete Custom Patient Information” field.

“Add/Delete Return-In Days” and “Add/Delete Medicine Names” are options by which the user can choose the interval for return visits to the clinic and customize the list of predefined medications, respectively.

“Customize Welcome Screen” causes the server to generate a new window where a number of settings can be customized, such as the “Greeting”, “Date and Time Message”, “Number of Patients Scheduled”, and “Number of Overdue Patients”. By default, each option is shown on the screen. To modify it, uncheck any section to hide it or check the section to have it displayed.

“Customize Vertical Menu” allows the user to customize the order of the specific menu items to be displayed. From a predefined list, the user selects the location of the item as it is to appear in the toolbar. By way of example, location 1 indicates the top of the toolbar. Alternatively, location 1 could represent the location at the bottom of the toolbar. A maximum limit of 10 items has been selected to be displayed in the toolbar, however, this number may be modified, as desired.

“Manage Users” and “Manage Physician Information” when selected by the user displays a list of existing users and physicians, respectively. Information associated with a particular user/physician may edited by selecting that user/physician. New users/physicians may also be added to the list.

“Manage Diagnoses” allows the user to customize the diagnosis list that is used in the “Patient Medical History” section of the “New Visit” page.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

What is claimed:

1. A method for using an administration of anticoagulation medication system accessed via a computer terminal over a network, the method comprising the steps of:
receiving current information for each patient's visit; and
automatically calculating a new weekly dose medication regimen based on the received information.

2. The method in accordance with claim 1, wherein the information received includes at least one of a patient's current weekly anticoagulation medication dose, current international normalized ratio, and international normalized ratio goal.

3. The method in accordance with claim 2, wherein the new weekly dose medication regimen is based on at least one of the patient's current weekly anticoagulation medication dose, current international normalize ratio, and international normalized ratio goal.

4. The method in accordance with claim 1, wherein the new weekly dose medication regimen is calculated based on a equation customizable by each user.

5. The method in accordance with claim 1, further comprising displaying standard medical guidelines in response to a user's request.

6. The method in accordance with claim 5, wherein the standard medical guidelines are published by American College of Chest Physicians.

7. The method in accordance with claim 1, further comprising converting the new weekly dose medication into daily doses based on a number of milligrams in a single pill.

8. The method in accordance with claim 7, wherein said converting step further comprises receiving from a user over the network a setting of a predetermined number of milligrams in a single pill as defined by the user.

9. The method in accordance with claim 1, wherein the anticoagulation medication is low molecular weight heparin.

10. The method in accordance with claim 1, further comprising searching a database of patient records based on at least one of patient's last name, patient's first name, medical record number, social security number and patient identification.

11. The method in accordance with claim 1, further comprising displaying a list of patients that are overdue for a scheduled visit as of a current date.

12. The method in accordance with claim 11, wherein the scheduled visit is overdue if delayed more than a predetermined number of days, as defined by a user, relative to a current date.

13. The method in accordance with claim 1, wherein the current information includes updated medication information, the method further comprising automatically displaying medication interaction messages in response to receiving the updated medication information.

14. The method in accordance with claim 1, further comprising displaying a list of patients scheduled for a visit on a current date.

15. The method in accordance with claim 14, further comprising selecting a particular patient from the list of patients scheduled.

16. The method in accordance with claim 1, further comprising generating a report of at least one of patient, physician, and clinic summary information.

17. The method in accordance with claim 16, wherein said report is customizable as to which fields are to be included therein.

18. The method in accordance with claim 17, wherein said report is customizable in at least one of sorting and grouping of the fields included therein.

19. The method in accordance with claim 1, further comprising the steps of:
accessing the system via a web site; and
receiving a selection of preferences to customize configuration of the web site.

20. The method in accordance with claim 1, further comprising automatically calculating a scheduled return visit based on whether the new weekly dose medication regimen has changed relative to the current weekly anticoagulation medication dose.

21. A system for administration of anticoagulation medication accessed via a computer terminal over a network, comprising:
means for receiving current information for each patient's visit; and
means for automatically calculating a new weekly dose medication regimen based on the received information.

22. The system in accordance with claim 21, wherein the current information received includes at least one of a patient's current weekly anticoagulation medication dose, current international normalized ratio, and international normalized ratio goal.

23. The system in accordance with claim 22, wherein the new weekly dose medication regimen is based on at least one of the patient's current weekly anticoagulation medication dose, current international normalize ratio, and international normalized ratio goal.

24. The system in accordance with claim 21, wherein the new weekly dose medication regimen is calculated based on a equation customizable by each user.

25. The system in accordance with claim 21, further comprising means for converting the new weekly dose medication into daily doses based on a number of milligrams in a single pill.

26. The system in accordance with claim 25, wherein said converting means comprises means for receiving from a user over the network a setting of a predetermined number of milligrams in a single pill as defined by the user.

27. The system in accordance with claim 21, wherein the anticoagulation medication is low molecular weight heparin.

28. The system in accordance with claim 21, further comprising means for displaying a list of patients that are overdue for a scheduled visit as of a current date.

29. The system in accordance with claim 28, wherein the scheduled visit is overdue if delayed more than a predetermined number of days, as defined by a user, relative to a current date.

30. The system in accordance with claim 21, wherein the current information includes updated medication information, the system further comprising means for automatically displaying medication interaction messages in response to receiving the updated medication information.

31. The system in accordance with claim 21, further comprising means for displaying a list of patients scheduled for a visit on a current date.

32. The system in accordance with claim 21, further comprising means for generating a report of at least one of patient, physician, and clinic summary information.

33. The system in accordance with claim 32, wherein said report is customizable as to which fields are to be included therein.

34. The system in accordance with claim 33, wherein said report is customizable in at least one of sorting and grouping of the fields included therein.

35. The system in accordance with claim 21, further comprising:
means for accessing the system via a web site; and
means for receiving a selection of preferences to customize configuration of the web site.

36. The system in accordance with claim 21, further comprising means for automatically calculating a scheduled return visit based on whether the new weekly dose medication regimen has changed relative to the current weekly anticoagulation medication dose.

37. A system for administration of anticoagulation medication accessed via a computer terminal over a network, comprising:
a processor for receiving current information for each patient's visit and automatically calculating a new weekly dose medication regimen based on the received information.

38. The system in accordance with claim 37, wherein the current information received includes at least one of a patient's current weekly anticoagulation medication dose, current international normalized ratio, and international normalized ratio goal.

39. The system in accordance with claim 38, wherein the new weekly dose medication regimen is based on at least one of the patient's current weekly anticoagulation medication dose, current international normalize ratio, and international normalized ratio goal.
